(19) United States
(12) Patent Application Publication
(10) Pub. No.: US 2026/0075379 A1
(43) Pub. Date: Mar. 12, 2026

(54) SPEAKER DEVICE FOR PROVIDING SPATIAL SOUND EFFECT BY USING ULTRASONIC SPEAKER

(71) Applicant: SAMSUNG ELECTRONICS CO., LTD., Suwon-si (KR)

(72) Inventors: Taeyoung KIM, Suwon-si (KR); Kyungrae KIM, Suwon-si (KR); Jungkyu KIM, Suwon-si (KR); Woohyun NAM, Suwon-si (KR); Yoonjae SON, Suwon-si (KR); Junyoung RHEE, Suwon-si (KR); Youngseock JANG, Suwon-si (KR)

(73) Assignee: SAMSUNG ELECTRONICS CO., LTD., Suwon-si (KR)

(21) Appl. No.: 19/310,481

(22) Filed: Aug. 26, 2025

Related U.S. Application Data
(63) Continuation of application No. PCT/KR2025/011049, filed on Jul. 25, 2025.

(30) Foreign Application Priority Data
Sep. 10, 2024 (KR) 10-2024-0123512
Feb. 7, 2025 (KR) 10-2025-0016157

(51) Int. Cl. H04S 7/00; H04R 5/02; H04S 3/00

(52) U.S. Cl. CPC H04S 7/303; H04R 5/02; H04S 3/008; H04S 2400/01; H04S 2400/11

(57) ABSTRACT

A speaker device includes a front speaker, an ultrasonic speaker that delivers, for a spatial sound effect, a spatial effect audio signal via reflection in an indoor space. The speaker device identifies spatial information of the indoor space, includes, in a first audio signal to be output from the front speaker, a low frequency signal extracted from the spatial effect audio signal included in a audio signal to be output. The low frequency signal is non-directional and a frequency of the low frequency signal is less than or equal to a preset frequency. The speaker device identifies, as a second audio signal, a high frequency signal extracted from the spatial effect audio signal included in the audio signal.

### CROSS-REFERENCE TO RELATED APPLICATIONS

This application is a continuation application, under 35 U.S.C. § 111(a), of International Patent Application No. PCT/KR2025/011049, filed on Jul. 25, 2025, which claims priority to Korean Patent Application No. 2024-0123512, filed on Sep. 10, 2024, and Korean Patent Application No. 2025-0016157, filed on Feb. 7, 2025, the disclosures of which are incorporated by reference herein in their entireties.

### BACKGROUND

### 1. Field

The disclosure relates to a speaker device for providing a spatial sound effect by using an ultrasonic speaker without a speaker for providing a spatial sound effect.

### 2. Description of Related Art

A speaker device is a device that converts sound into an electrical signal for reproduction. In early stages, a simple induction scheme (an inductive electronic device) and a piezoelectric scheme were mainly used. However, with the recent technological developments, more advanced speakers have been introduced. A multi-channel speaker system provides an immersive sound experience by providing stereoscopic sound by using a plurality of speaker units to configure 5.1 channels, 7.1 channels, or even more channel configurations.

Multi-channel speakers have the advantage of optimizing a position of each speaker so as to efficiently use space. However, some multi-channel systems require numerous speaker units and complex installations to generate spatial sound effects so that installation is difficult in a limited space and it may be difficult to harmonize the installation with existing interior designs. As a result, in environments with space constraints, they may occupy an unnecessary space. Therefore, there is a demand for a speaker device for providing a spatial sound effect and allowing users to effectively use space.

### SUMMARY

According to an aspect of the disclosure, there is provided a speaker device including: a front speaker; an ultrasonic speaker configured to deliver, for a spatial sound effect, a spatial effect audio signal via reflection in an indoor space; memory storing instructions; and at least one processor, wherein the instructions, when executed by the at least one processor, cause the speaker device to: identify spatial information of the indoor space; include, in a first audio signal to be output from the front speaker, a low frequency signal extracted from the spatial effect audio signal included in a third audio signal to be output, wherein the low frequency signal is non-directional and a frequency of the low frequency signal is less than or equal to a preset frequency; identify, as a second audio signal, a high frequency signal extracted from the spatial effect audio signal included in the third audio signal, wherein a frequency of the high frequency signal is greater than the preset frequency; identify a path of the second audio signal in the indoor space, according to the spatial information; identify a directivity direction of the ultrasonic speaker, according to the identified path of the second audio signal; control the ultrasonic speaker to face the identified directivity direction; and control the ultrasonic speaker to output the second audio signal.

According to an aspect of the disclosure, there is provided a method of outputting audio from a speaker device including an ultrasonic speaker, the method including: including, in a first audio signal to be output from a front speaker, a low frequency signal that is extracted from a spatial effect audio signal included in a third audio signal to be output from the speaker device, wherein the low frequency signal is non-directional and has a frequency that is less than or equal to a preset frequency; identifying, as a second audio signal, a high frequency signal extracted from the spatial effect audio signal included in the third audio signal, wherein a frequency of the high frequency signal is greater than the preset frequency; identifying spatial information of an indoor space in which a user is positioned; identifying a path of the second audio signal in the indoor space, according to the spatial information of the indoor space; identifying a directivity direction of the ultrasonic speaker, according to the identified path of the second audio signal; controlling the ultrasonic speaker to face the identified directivity direction; and outputting the second audio signal via the ultrasonic speaker.

### BRIEF DESCRIPTION OF THE DRAWINGS

The above and other aspects and/or features of one or more embodiments of the disclosure will be more apparent from the following detailed description, taken in conjunction with the accompanying drawings, in which:

FIG. 1 is a diagram illustrating an audio listening environment in which rear speakers are installed;

FIG. 2 is a diagram illustrating an audio listening environment in which rear speakers are installed;

FIG. 3 is a diagram illustrating a spatial sound effect generated by an ultrasonic speaker included in a speaker device according to an embodiment of the disclosure;

FIG. 4A is a diagram showing separation of a spatial effect audio signal included in an audio signal according to directivity, according to an embodiment of the disclosure;

FIG. 4B is a diagram showing addition of a non-directional audio signal to a front speaker output audio signal, the non-directional audio signal being of a spatial effect audio signal, according to an embodiment of the disclosure;

FIG. 5A is a diagram showing a user in an indoor space obtaining spatial information of the indoor space by using a spatial detection sensor, according to an embodiment of the disclosure;

FIG. 5B is a diagram showing a user identification sensor obtaining a position of a user, according to an embodiment of the disclosure;

FIG. 6 is a diagram showing setting a preset according to obtained spatial information, according to an embodiment of the disclosure;

FIG. 7 is a graph showing widths and depths corresponding to a plurality of pieces of spatial information, according to an embodiment of the disclosure;

FIG. 8 is a diagram illustrating an audio signal path of an ultrasonic speaker which is adjusted according to spatial information of an indoor space, according to an embodiment of the disclosure;

FIG. 9A illustrates an example of a speaker device including an ultrasonic speaker according to an embodiment of the disclosure;

FIG. 9B is a perspective view of a speaker device including an ultrasonic speaker according to an embodiment of the disclosure;

FIG. 10 is a diagram illustrating a speaker mount for tilt control and pan control by an ultrasonic speaker, according to spatial information of an indoor space, according to an embodiment of the disclosure;

FIG. 11 is a diagram illustrating an example of setting equalization, a tilt angle, and a pan angle, based on preset information, according to an embodiment of the disclosure;

FIG. 12 is a diagram illustrating a spatial sound effect generated by a speaker device including an ultrasonic speaker, according to an embodiment of the disclosure;

FIG. 13 is a diagram illustrating a spatial sound effect generated by a speaker device including an ultrasonic speaker, according to an embodiment of the disclosure;

FIG. 14 is a diagram illustrating a spatial sound effect generated by a speaker device including an ultrasonic speaker, according to an embodiment of the disclosure;

FIG. 15 is a diagram illustrating a spatial sound effect generated by a speaker device including an ultrasonic speaker, according to an embodiment of the disclosure;

FIG. 16 illustrates an example of inputting an indoor space size to a speaker device, according to an embodiment of the disclosure;

FIG. 17 is a diagram illustrating an example of selecting any one of a plurality of pieces of preset information, according to an embodiment of the disclosure;

FIG. 18 is a diagram for illustrating an example in which a user inputs a position of the user, according to an embodiment of the disclosure;

FIG. 19 is a flowchart illustrating a method of generating a spatial sound effect by a speaker device including an ultrasonic speaker, according to an embodiment of the disclosure;

FIG. 20 is a flowchart illustrating a method of generating a spatial sound effect by a speaker device including an ultrasonic speaker, according to an embodiment of the disclosure; and

FIG. 21 is a block diagram of a speaker device including an ultrasonic speaker, according to an embodiment of the disclosure.

### DETAILED DESCRIPTION

The terms used in the disclosure will be briefly defined, and an embodiment of the disclosure will be described in detail.

Although the terms used in the disclosure are selected from among common terms that are currently widely used in consideration of their functions in an embodiment of the disclosure, the terms may vary according the intention of one of ordinary skill in the art, a precedent, or the advent of new technology. Also, in some cases, the terms are discretionally selected by the applicant, and the meaning of those terms will be described in detail in the corresponding part of the detailed description of an embodiment of the disclosure. Therefore, the terms used in the disclosure should not be interpreted based on only their names but should be defined based on the meaning of the terms together with the descriptions throughout the disclosure.

Throughout the disclosure, the expression “at least one of a, b or c” indicates only a, only b, only c, both a and b, both a and c, both b and c, all of a, b, and c, or variations thereof.

Also, in the disclosure, when a part “includes” or “comprises” an element, unless there is a particular description contrary thereto, the part can further include other elements, not excluding the other elements. Also, the terms such as “ . . . unit,” “module,” or the like used in the disclosure indicate a unit, which processes at least one function or operation, and the unit or the module may be implemented by hardware or software, or by a combination of hardware and software.

It should be understood that blocks in each flowchart and combinations of flowcharts are executable by one or more computer programs including computer-executable instructions. The one or more computer programs may all be stored in a single memory, or may be divided and stored in a plurality of different memories.

Unless the context clearly indicates otherwise, the singular forms (e.g., “a”, “an”, and “the”) are intended to include the plural forms as well. Therefore, for example, the expression “component surface” may indicate one or more of such surfaces.

All functions or operations described in the present disclosure may be processed by one processor or a combination of processors. The one processor or the combination of processors may be circuitry configured to perform processing and may include circuit devices such as an application processor (AP), a communication processor (CP), a graphics processing unit (GPU), a neural processing unit (NPU), a microprocessor unit (MPU), a system on chip (SoC), an integrated chip (IC), etc.

Hereinafter, an embodiment of the disclosure will be described in detail with reference to the accompanying drawings to allow one of skill in the art to easily implement the embodiment. However, the disclosure may be embodied in many different forms and should not be construed as being limited to an embodiment set forth herein. In addition, in the drawings, parts irrelevant to the description are omitted to clearly describe an embodiment of the disclosure, and like elements are denoted by like reference numerals throughout the disclosure.

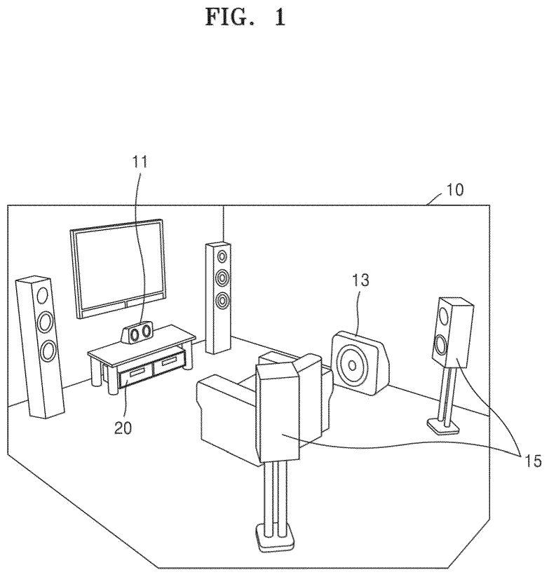

FIG. 1 is a diagram illustrating an audio listening environment in which rear speakers are installed.

Referring to FIG. 1, various speaker devices are installed in an indoor space 10. FIG. 1 illustrates a front speaker 11 positioned facing a listener, a side speaker 13 positioned on the listener's side, and a rear speaker 15 positioned behind the listener. As shown in FIG. 1, because the various speaker devices are three-dimensionally placed, a user (listener) may experience spatial sound (surround audio). However, in order for the user to experience the spatial sound, as shown in FIG. 1, various speaker devices have to be placed at various positions in the indoor space 10, which results in limitation in the use of the indoor space 10. For example, a separate space has to be ensured for the side speaker 13 or the rear speaker 15 in the indoor space 10. When a spatial sound effect may be generated without the side speaker 13 or the rear speaker 15, there is no need to ensure a space for various speaker devices.

Spatial sound refers to audio (sound) that is reproduced via multiple speakers in various direction around the listener, and a spatial sound effect refers to an effect in which the listener experiences of listening to stereoscopic sound according to the spatial sound effect. The disclosure relates to allowing a listener to experience a spatial sound effect without an actual surround speaker or rear speaker which outputs spatial sound. In the disclosure the surround speaker may be referred to as a side speaker and/or a rear speaker.

For a spatial sound effect, various speaker devices may be required. Also, in a case of a speaker device such as a sound bar which provides various audio channels, audio performance experienced by a user may vary according to an installation space. In addition, the difficulty of installing an entire speaker system varies according to whether the front speaker 11, the side speaker 13, or the rear speaker 15 is connected to a main amplifier 20 by wire or wirelessly.

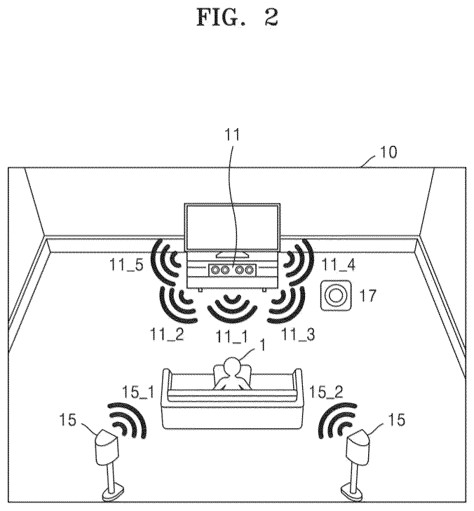

FIG. 2 is a diagram illustrating an audio listening environment in which rear speakers are installed.

FIG. 2 shows an example of a spatial sound output system including rear speakers. For example, the front speaker 11 may include three front speakers, that is, a front center speaker C 11_1, a front left speaker L 11_2, and a front right speaker R 11_3. Also, the front speaker 11 may include a surround left speaker LS 11_4 and a surround right speaker RS 11_5. The surround left speaker LS 11_4 and the surround right speaker RS 11_5 may not be included in the front speaker 11 and may be installed as a standalone speaker in the indoor space 10.

The rear speaker 15 may be positioned in the both rear sides of a user 1. The rear speaker 15 may include a left rear speaker LB 15_1 positioned in the left of the user 1 and a right rear speaker RB 152 positioned in the right of the user 1. Also, the spatial sound output system may include a woofer 17. Considering all speakers described above, audio channels of the spatial sound output system shown in FIG. 2 are 7.1 (where “0.1” in “7.1” corresponds to a woofer). Although FIG. 2 illustrates the spatial sound output system with 7.1 audio channels, the spatial sound output system may be implemented with various audio channels. For example, the spatial sound output system may be implemented with audio channels of 3.1 (x.1 corresponds to a subwoofer), 5.1, 5.1.1 (x.x.1 corresponds to a ceiling speaker), 7.1.1, etc.

As described with FIG. 1, the rear speaker 15 may realize the spatial sound effect by being arranged in the left and right of the user 1, but occupies a space. Also, when it is required to connect the rear speaker 15 by wire to the front speaker 11 including an amplifier, wires have to be placed in the indoor space 10, and thus, aesthetic issues may occur. Also, for a rear sound effect via the rear speaker 15, it may be required to separately purchase the rear speaker 15.

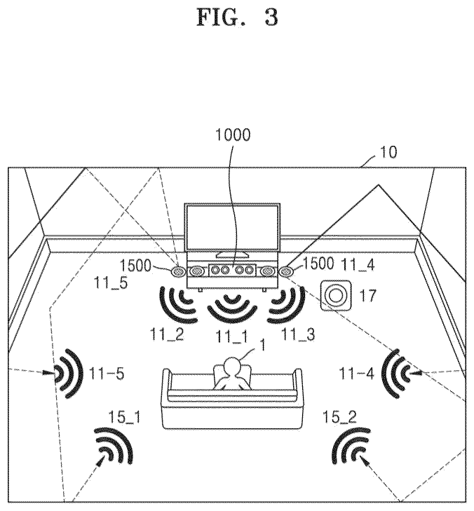

FIG. 3 is a diagram illustrating a spatial sound effect generated by an ultrasonic speaker included in a speaker device according to an embodiment of the disclosure.

Referring to FIG. 3, a spatial sound effect system corresponding to same 7.1 audio channels is implemented without the rear speaker 15 of FIG. 2. A speaker device 1000 according to an embodiment of the disclosure may include an ultrasonic speaker 1500 capable of generating a spatial sound effect.

The ultrasonic speaker 1500 is a speaker that uses an ultrasonic frequency, and generates frequencies equal to or greater than 20 kHz that is higher than a general human hearing range (i.e., 20 Hz to 20 kHz). The ultrasonic speaker 1500 has directivity that may be propagated in a particular direction in the air, and thus, allows an audio signal to be concentrated on a target point. Therefore, the ultrasonic speaker 1500 makes least noise and may transmit the audio signal in the particular direction.

According to an embodiment of the disclosure, when the ultrasonic speaker 1500 transmits the audio signal at an appropriate angle to a wall surface of the indoor space 10, based on the directivity of the ultrasonic speaker 1500, the audio signal may be delivered from the left and right rear of the user 1. Therefore, without the rear speaker 15, the ultrasonic speaker 1500 may operate as the rear speaker 15. Although not illustrated, the ultrasonic speaker 1500 may be substituted for the side speaker 13 shown in FIG. 1 or a ceiling speaker, according to an angle at which an audio signal is transmitted to a wall surface.

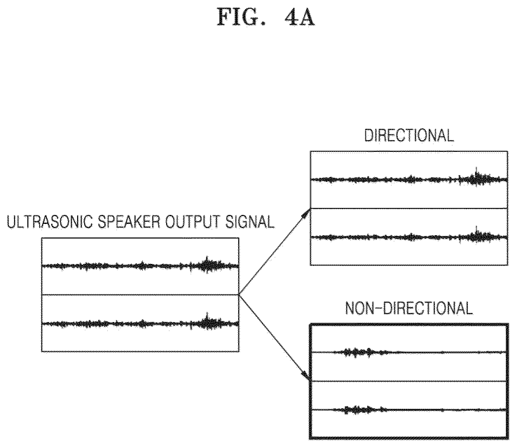

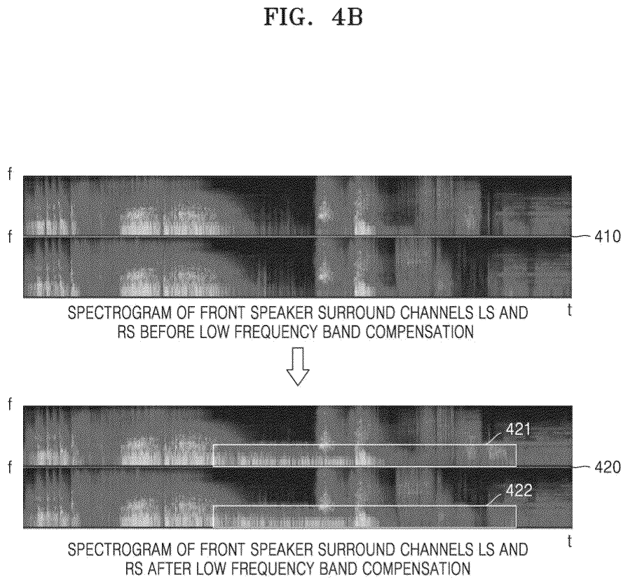

FIG. 4A is a diagram showing separation of a spatial effect audio signal included in an audio signal according to directivity, according to an embodiment of the disclosure.

Before descriptions, a spatial effect audio signal, a directional signal (directional audio signal), and a non-directional signal (non-directional audio signal) are first described.

When a user listens to audio, there may be audio signals that are heard by being distinguished between different directions including left and right directions or up and down directions, and the audio signals may be the spatial effect audio signal. For example, the spatial effect audio signal may include an audio signal that the user may hear in a rear direction or a side direction. The spatial effect audio signal may include a directional signal (or a directional audio signal). Regarding the directional audio signal, for example, a line of a song of a singer may be heard from the left rear, and a next line may be heard from the right rear. In this manner, the lines of the song which are heard by being distinguished between different directions are converted into audio signals to generate the directional signal (or the directional audio signal). Also, unlike in the directional signal, an audio signal without directivity may be referred to as a non-directional audio signal or a non-directional signal. Therefore, for example, in the disclosure, a ‘non-directional low frequency signal’ may mean a low frequency audio signal without directivity.

The ultrasonic speaker 1500 introduced in FIG. 3 above does not output a low frequency band of an audio signal. According to an embodiment of the disclosure, a non-directional low frequency signal of an audio signal to be output via the ultrasonic speaker 1500, the non-directional low frequency signal being equal to or less than a preset frequency, may be included in a first audio signal output from a front speaker. By doing so, a loss of a low frequency signal to be output from the ultrasonic speaker 1500 may be minimized. The preset frequency may be, for example, 400 Hz. Obviously, this is merely an embodiment of the disclosure, and the preset frequency may be greater or less than 400 Hz. By doing so, a processor of the speaker device 1000 may compensate for a low-frequency band audio signal of a spatial effect audio signal to be output from the ultrasonic speaker 1500.

FIG. 4B is a diagram showing addition of a non-directional audio signal to a front speaker output audio signal, the non-directional audio signal being of a spatial effect audio signal, according to an embodiment of the disclosure.

According to an embodiment of the disclosure, the speaker device 1000 may identify a signal of a frequency greater than a preset frequency as a second audio signal to be output from the ultrasonic speaker 1500, the signal being of a spatial effect audio signal included in an audio signal to be output. The preset frequency may be, for example, 400 Hz. Obviously, this is merely an embodiment of the disclosure, and the preset frequency may be greater or less than 400 Hz. The second audio signal is a signal excluding a non-directional low frequency signal and including a directional audio signal of the spatial effect audio signal. Here, the low frequency signal may be an audio signal with a frequency equal to or less than a preset frequency.

Referring to FIG. 4B, a spectrogram 410 is a spectrogram of front speaker surround channels LS and RS output from the front speaker 11 of the speaker device 1000 of FIG. 3 before low frequency band compensation shown in FIG. 4A is performed. As shown in FIG. 3, the front speaker 11 may include the surround left speaker LS 11_4 and the surround right speaker RS 11_5 which respectively correspond to the surround channels LS and RS. In the spectrogram 410, the upper spectrogram is a spectrogram corresponding to the surround left speaker LS 114, and the lower spectrogram is a spectrogram corresponding to the surround right speaker RS 11_5.

A spectrogram is a graph that visually represents energy of frequency components of an audio signal over time. The horizontal axis of the spectrogram indicates a time axis and the vertical axis thereof indicates a frequency axis. In the spectrogram, the horizontal axis shows how the audio signal changes over time, and the vertical axis shows how audio components are distributed in a particular frequency range. In the spectrogram, a degree of color or brightness indicating energy for each frequency and time may be visually represented. In general, bright color or high brightness means strong energy, and dark color or low brightness means weak energy.

A spectrogram 420 is a spectrogram of front speaker surround channels LS and RS output from the front speaker 11 of the speaker device 1000 of FIG. 3 after low frequency band compensation shown in FIG. 4A is performed. In the spectrogram 420, the upper spectrogram is a spectrogram corresponding to the surround left speaker LS 114, and the lower spectrogram is a spectrogram corresponding to the surround right speaker RS 11_5. In the spectrogram 420, the spectrogram corresponding to the surround left speaker LS 11_4 includes a part 421 to which the low frequency band compensation has been performed, and the lower spectrogram of the spectrogram 420 which corresponds to the surround right speaker RS 11_5 includes a part 422 to which the low frequency band compensation has been performed.

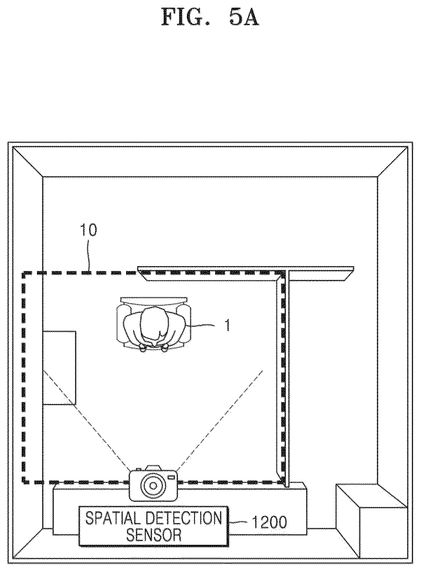

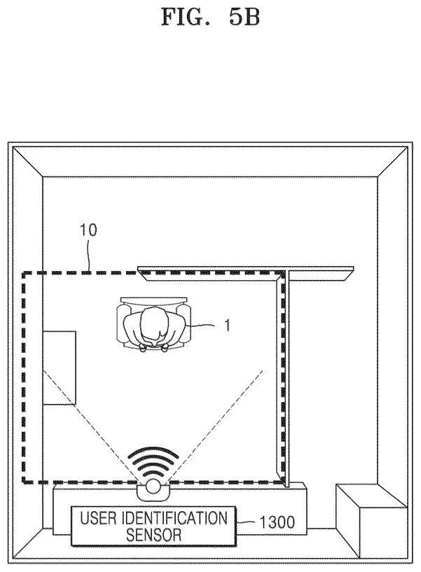

FIG. 5A is a diagram showing a user in an indoor space obtaining spatial information of the indoor space by using a spatial detection sensor, according to an embodiment of the disclosure.

According to an embodiment of the disclosure, spatial information of the indoor space 10 in which the user (the listener 1) is positioned may be identified by a spatial detection sensor 1200, according to an embodiment of the disclosure. According to an embodiment of the disclosure, the speaker device 1000 may include the spatial detection sensor 1200.

The spatial detection sensor 1200 is a sensor configured to detect a depth or a shape of a space and is also referred to as a three-dimensional (3D) sensor or a distance sensor. The spatial detection sensor 1200 may be one of a light detection and ranging (LIDAR), a time-of-flight (ToF) camera, a stereo camera, an ultrasonic sensor, an infrared sensor, a 3D scanner, and a depth camera, but the disclosure is not limited thereto. The spatial detection sensor 1200 may collect 3D information about the indoor space 10.

According to an embodiment of the disclosure, the spatial detection sensor 1200 may detect at least one piece of information about an area, a length, and a height of the indoor space 10. In order to detect at least one piece of information about the area, the length, and the height of the indoor space 10, the spatial detection sensor 1200 may include a depth measurement sensor capable of detecting a depth of the indoor space 10. According to an embodiment of the disclosure, as the spatial detection sensor 1200 detects at least one piece of information about the area, the length, and the height of the indoor space 10, information about the shape of the indoor space 10 may also be detected. For example, according to information detected by the spatial detection sensor 1200, whether the shape of the indoor space 10 is a square shape, a round shape, an irregular polygonal shape, etc. may be identified.

According to an embodiment of the disclosure, the spatial information may not be detected by the spatial detection sensor 1200 but may be replaced by at least one of a plurality of pieces of preset information included in the speaker device 1000. For example, when the speaker device 1000 does not include the spatial detection sensor 1200 or the spatial detection sensor 1200 does not operate, preset information that is most relevant to an indoor space in which a user is currently positioned and is from among a plurality of pieces of preset information stored in a memory of the speaker device 1000 and corresponding to a plurality of pieces of spatial information may be selected.

When the speaker device 1000 does not include the spatial detection sensor 1200 and corresponding spatial information is not stored in the memory, the speaker device 1000 may receive spatial information corresponding to the indoor space from an external electronic device. For example, the external electronic device may include the spatial detection sensor 1200, and obtains spatial information of the indoor space via the spatial detection sensor 1200. According to an embodiment of the disclosure, the speaker device 1000 may receive the spatial information from the external electronic device via communication and may use the spatial information as information for audio output.

FIG. 5B is a diagram showing a user identification sensor obtaining a position of a user, according to an embodiment of the disclosure.

According to an embodiment of the disclosure, the speaker device 1000 may include a user identification sensor 1300 capable of identifying a position of the user 1, according to an embodiment of the disclosure. The user identification sensor 1300 is a sensor capable of not only identifying whether the user 1 is present but also identifying a distance and an angle of the user 1 from the speaker device 1000. Therefore, similar to the spatial detection sensor 1200, the user identification sensor 1300 may include a depth measurement sensor. The spatial detection sensor 1200 may be, for example, any one of an infrared (IR) sensor, an ultrasonic sensor, a microwave (radar) sensor, a camera-based sensor, and a real-time position tracking sensor, but the disclosure is not limited thereto.

According to an embodiment of the disclosure, the spatial information may include position information of the user 1. The speaker device 1000 may identify a position of the user 1 via the user identification sensor 1300. The user identification sensor 1300 may be included in the speaker device 1000 or may be included in the external electronic device. When the user identification sensor 1300 is included in the external electronic device, the speaker device 1000 may receive, from the external electronic device, position information of a user which is obtained via the user identification sensor 1300.

According to an embodiment of the disclosure, the user 1 may provide the speaker device 1000 with preset information as to his/her position. An example in which the user 1 provides his/her position to the speaker device 1000 will be described at a later time.

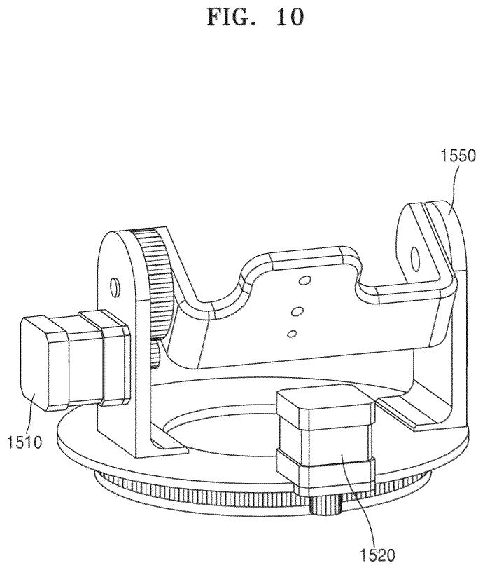

The speaker device 1000 may take actions to allow an output-target audio signal to be transmitted to the position of the user 1, based on the identified position of the user 1. For example, the ultrasonic speaker 1500 may control a directivity direction of the ultrasonic speaker 1500 so as to allow ultrasonic waves to be delivered to the position of the user 1. The control of the directivity of the ultrasonic speaker 1500 will be described in detail below with reference to FIGS. 10A and 10B.

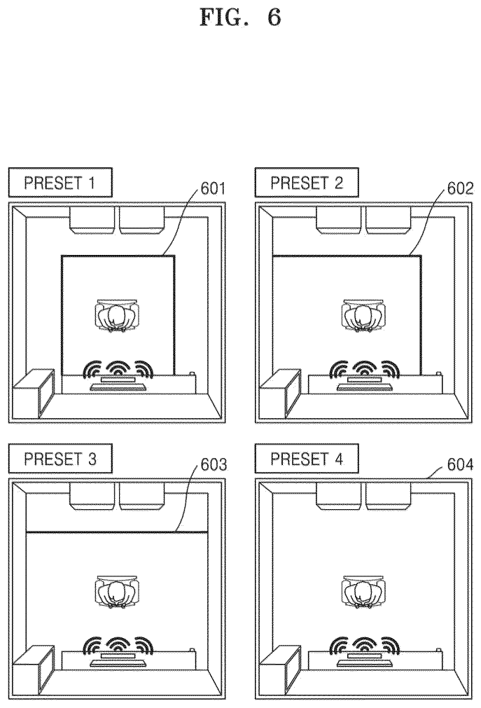

FIG. 6 is a diagram showing setting a preset according to obtained spatial information, according to an embodiment of the disclosure.

According to an embodiment of the disclosure, the speaker device 1000 may determine preset information, based on spatial information obtained by the spatial detection sensor 1200. The speaker device 1000 may further include a memory, and a plurality of pieces of preset information corresponding to various indoor spaces may be stored in the memory. FIG. 6 illustrates a preset 1 601, a preset 2 602, a preset 3 603, and a preset 4 604, as an example, but the disclosure is not limited thereto, and fewer or more pieces of preset information may be provided.

Alternatively, the speaker device 1000 may receive the plurality of pieces of preset information from an external electronic device or server. A plurality of different indoor spaces may respectively correspond to a plurality of pieces of spatial information, and the plurality of pieces of spatial information may respectively correspond to the plurality of pieces of preset information. In other words, spatial information about the various indoor spaces may be pre-stored as preset information in the memory of the speaker device 1000.

According to an embodiment of the disclosure, the processor of the speaker device 1000 may compare the spatial information with the plurality of pieces of preset information, and may select preset information among the plurality of pieces of preset information, the preset information being most relevant to the spatial information. For example, it is assumed that, according to the spatial information, a width of the indoor space is 4.3 m, a length thereof is 6 m, and a height thereof is 2.5 m. When it is assumed that the preset 1 601 has values in which a width is 3.0 m, a length is 5.5 m, and a height is 2.3 m, the preset 2 602 has values in which a width is 4.5 m, a length is 6.5 m, and a height is 2.5 m, the preset 3 603 has values in which a width is 5.5 m, a length is 6.5 m, and a height is 2.5 m, and the preset 4 604 has values in which a width is 6 m, a length is 7 m, and a height is 2.5 m, the preset 2 602 having the smallest deviation between a size of a current indoor space and values of the preset information among the plurality of pieces of preset information may be selected.

A method by which, when a user inputs indoor space information, the speaker device 1000 automatically selects the most relevant preset information may be used.

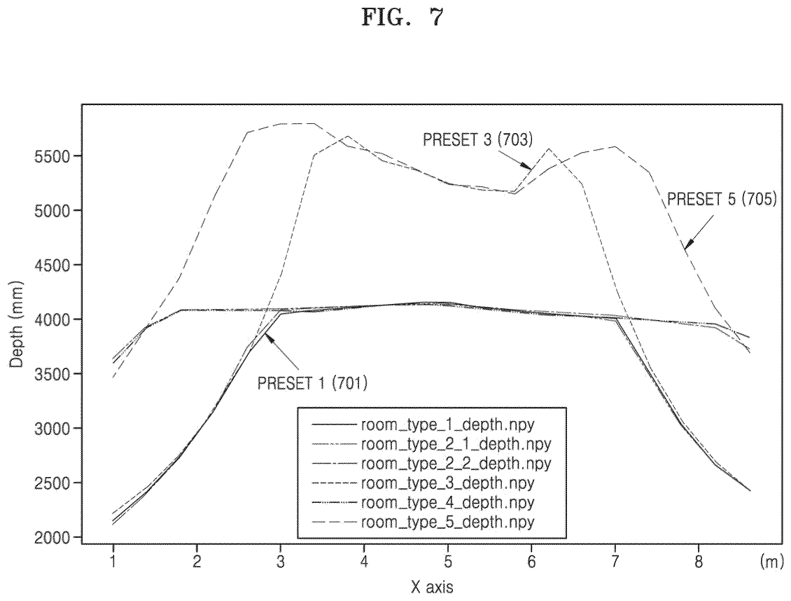

FIG. 7 is a graph showing widths and depths corresponding to a plurality of pieces of spatial information, according to an embodiment of the disclosure.

The graph of FIG. 7 shows depths (y axis) and widths (x axis) corresponding to a plurality of pieces of preset information. For example, an indoor space corresponding to a preset 1 701 is about 4.5 m in width and about 4 m in depth (length), an indoor space corresponding to a preset 3 703 is about 3.5 m in width and about 5.5 m in depth, and an indoor space corresponding to a preset 5 705 is about 5.5 m in width and about 5.5 m in depth. The spatial detection sensor 1200 may detect width and depth information with respect to an indoor space, as shown in FIG. 7. Although not illustrated in FIG. 7, the spatial detection sensor 1200 may detect a height of the indoor space.

According to an embodiment of the disclosure, when spatial information about at least one of a width, a depth, or a height of an indoor space is detected by the spatial detection sensor 1200, an audio signal directivity direction of the ultrasonic speaker 1500 may be determined (e.g., identified) based on the spatial information. According to an embodiment of the disclosure, when spatial information about at least one of a width, a depth, or a height of an indoor space is detected by the spatial detection sensor 1200, a preset having the most relevant value to a width, a depth, and/or a height which is included in the obtained spatial information is selected among a plurality of pieces of preset information. An audio signal directivity direction of the ultrasonic speaker 1500 may be determined based on the selected preset.

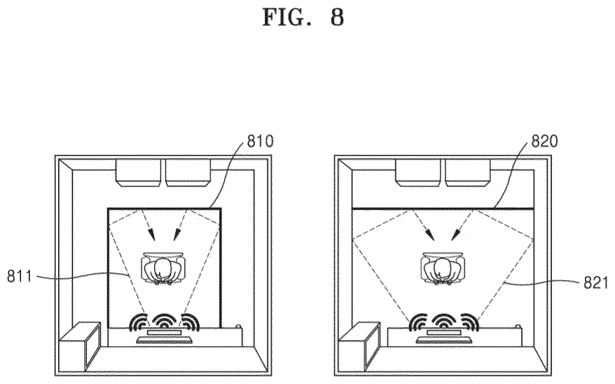

FIG. 8 is a diagram illustrating an audio signal path of an ultrasonic speaker which is adjusted according to spatial information of an indoor space, according to an embodiment of the disclosure.

Referring to FIG. 8, a first indoor space 810 and a second indoor space 820 which have different space sizes are shown.

When the speaker device 1000 obtains spatial information of the first indoor space 810, a path of an audio signal which is output from the ultrasonic speaker 1500 so as to be substituted for a rear speaker may be set as 811.

When a structure of the indoor space becomes different, a path of an audio signal output from the ultrasonic speaker 1500 has to be different. When the speaker device 1000 obtains spatial information of the second indoor space 820, a path of an audio signal which is output from the ultrasonic speaker 1500 so as to be substituted for a rear speaker may be set as 821. As the second indoor space 820 has a width greater than the first indoor space 810, the path of the audio signal 821 which is output from the ultrasonic speaker 1500 so as to be substituted for a rear speaker is transmitted at a more acute angle based on a width of the speaker device 1000, compared to the path of the audio signal 811 output in the first indoor space 810.

More detailed content about path adjustment of an audio signal output from the ultrasonic speaker 1500, when the ultrasonic speaker 1500 is substituted for a spatial sound effect generation speaker, will be described at a later time.

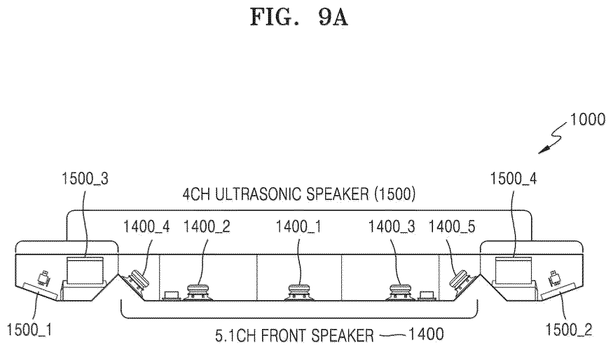

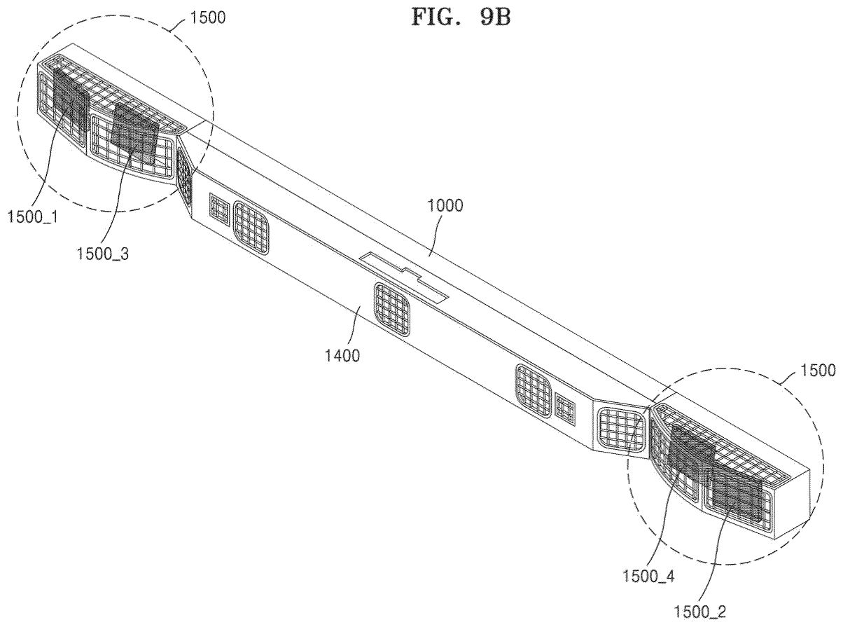

FIG. 9A illustrates an example of a speaker device including an ultrasonic speaker according to an embodiment of the disclosure.

The speaker device 1000 of FIG. 9A includes a front speaker 1400 and the ultrasonic speaker 1500.

Referring to FIG. 9A, the front speaker 1400 includes, for example, speaker channels of 5.1 channels (speaker layout), and the ultrasonic speaker 1500 includes speaker channels of 4 channels (speaker layout).

Therefore, the front speaker 1400 may include a front center speaker C 1400_1, a front left speaker L 14002, a front right speaker R 1400_3, a surround left speaker LS 14004, and a surround right speaker RS 1400_5. However, this is merely an example, and the front speaker 1400 may include various speaker layouts including some speaker layouts of 5.1.1 channels, 5 channels, 3.1.1 channels, 3.1 channels, 3 channels, etc.

The ultrasonic speaker 1500 may include a left rear speaker LB 1500_1, a right rear speaker RB 1500_2, a left upper speaker LT 1500_3, and a right upper speaker RT 1500_4. Therefore, the ultrasonic speaker 1500 may include (be substituted for) the left rear speaker LB 1500_1 arranged in the both rear sides of the user 1 and the right rear speaker RB 1500_2 arranged in the right of the user 1. Also, the ultrasonic speaker 1500 may include the left upper speaker LT 1500_3 and the right upper speaker RT 1500_4 which output an audio signal toward a ceiling (top).

Left and right directivity directions of the left rear speaker LB 1500_1 and the right rear speaker RB 1500_2 of the ultrasonic speaker 1500 may be determined by a pan control motor. In order for the left rear speaker LB 1500_1 and the right rear speaker RB 1500_2 of the ultrasonic speaker 1500 to be substituted for an actual left rear speaker and an actual right rear speaker, a transmission direction of an audio signal has to be determined to allow the audio signal to be delivered from the rear of a user. When a transmission direction of the audio signal is determined as in FIG. 8 above, the left and right directivity directions of the left rear speaker LB 1500_1 and the right rear speaker RB 1500_2 are determined by the pan control motor, accordingly.

Also, when the ultrasonic speaker 1500 transmits an audio signal to the ceiling, and a transmission direction for a spatial sound effect is determined, up and down directivity directions of the left upper speaker LT 1500_3 and the right upper speaker RT 1500_4 of the ultrasonic speaker 1500 may be determined by a tilt control motor.

FIG. 9B is a perspective view of a speaker device including an ultrasonic speaker according to an embodiment of the disclosure.

FIG. 9B is the perspective view of the speaker device 1000 shown in FIG. 9A.

The speaker device 1000 may include the front speaker 1400 and the ultrasonic speaker 1500. The ultrasonic speaker 1500 may include a left rear speaker LB 1500_1, a right rear speaker RB 15002, a left upper speaker LT 1500_3, and a right upper speaker RT 1500_4, but the disclosure is not limited thereto. In an embodiment of the disclosure, the ultrasonic speaker 1500 may include only the left rear speaker LB 1500_1 and the right rear speaker RB 1500_2, or may include only the left upper speaker LT 1500_3 and the right upper speaker RT 1500_4.

FIG. 10 is a diagram illustrating a speaker mount for tilt control and pan control by an ultrasonic speaker, according to spatial information of an indoor space, according to an embodiment of the disclosure.

Referring to FIG. 10, a speaker mount 1550 according to an embodiment of the disclosure may include a pan motor 1520 for pan control and a tilt motor 1510 for tilt control. The speaker mount 1550 includes not only the pan motor 1520 and the tilt motor 1510 but also includes a gear for enabling, by an operation of the pan motor 1520, left and right movements of a speaker mounted at the speaker mount 1550 and a gear for enabling, by an operation of the tilt motor 1510, up and down movements of the speaker mounted at the speaker mount 1550.

While FIG. 10 shows the speaker mount 1550 including both the pan motor 1520 for the pan control and the tilt motor 1510 for the tilt control, the speaker mount 1550 may include only one of the pan motor 1520 for the pan control and the tilt motor 1510 for the tilt control, according to a usage.

For example, the ultrasonic speaker 1500 shown in FIGS. 9A and 9B may include the left rear speaker LB 1500_1, the right rear speaker RB 1500_2, the left upper speaker LT 1500_3, and the right upper speaker RT 15004, and in this regard, when the left rear speaker LB 1500_1 and the right rear speaker RB 1500_2 need only pan control, the left rear speaker LB 1500_1 and the right rear speaker RB 15002 may include only the pan motor 1520. Also, when the left upper speaker LT 1500_3 and the right upper speaker RT 1500_4 need only tilt control, the left upper speaker LT 1500_3 and the right upper speaker RT 1500_4 may include only the tilt motor 1510.

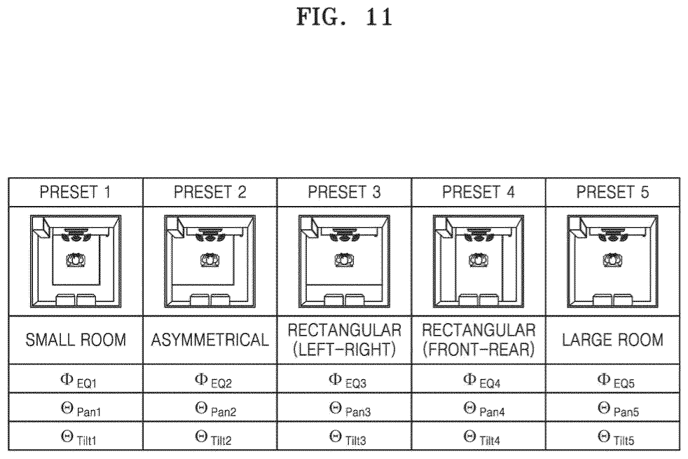

FIG. 11 is a diagram illustrating an example of setting equalization, a tilt angle, and a pan angle, based on preset information, according to an embodiment of the disclosure.

Referring to FIG. 11, the speaker device 1000 according to an embodiment of the disclosure may include a plurality of pieces of preset information in the memory. In the example of FIG. 11, 5 pieces of preset information are shown. Each preset information corresponds to spatial information of an indoor space. For example, a preset 1 among the plurality of pieces of preset information corresponds to spatial information of a small room. A preset 2 corresponds to spatial information of an asymmetric room. A preset 3 corresponds to spatial information of a rectangular room with a wide left-to-right width. A preset 4 corresponds to spatial information of a rectangular room that is long in a longitudinal direction. A preset 5 corresponds to spatial information of a large room. The plurality of pieces of preset information may be pre-stored in the speaker device 1000. While FIG. 11 illustrates the 5 pieces of preset information, the speaker device 1000 may include more preset information.

Preset information corresponds to spatial information, and thus, may also include information about a pan angle and/or a tilt angle of the ultrasonic speaker 1500 which indicate in which direction the ultrasonic speaker 1500 is to transmit audio. In other words, as a path of an audio signal output from the ultrasonic speaker 1500 is determined based on spatial information, a pan angle and/or a tilt angle of the ultrasonic speaker 1500 may be determined based on the determined path of the audio signal.

Referring to FIG. 11, the preset 1 among the preset information may include pan angle and/or tilt angle information such as Θ_{Pan1} and Θ_{Tilt1}.

According to an embodiment of the disclosure, the preset information may also include φ_{EQ} that is equalization (EQ) information. For example, the speaker device 1000 may set EQ for the ultrasonic speaker 1500, based on the spatial information corresponding to the preset information. EQ setting of audio may refer to a procedure for individually adjusting sound by adjusting a frequency response of the audio. Via the EQ setting, sound of a particular frequency band of the audio may be emphasized or decreased, such that a desired tone and sound quality may be generated. In other words, filtering of a particular frequency range may be performed according to the EQ setting. The processor of the speaker device 1000 may set optimal EQ according to a user's environment by recognizing a distance between the speaker device 1000 and a user, distances between respective speakers in the speaker device 1000, a level between channels, and a frequency characteristic. Such set EQ may be stored in the memory of the speaker device 1000 as a part of the preset information.

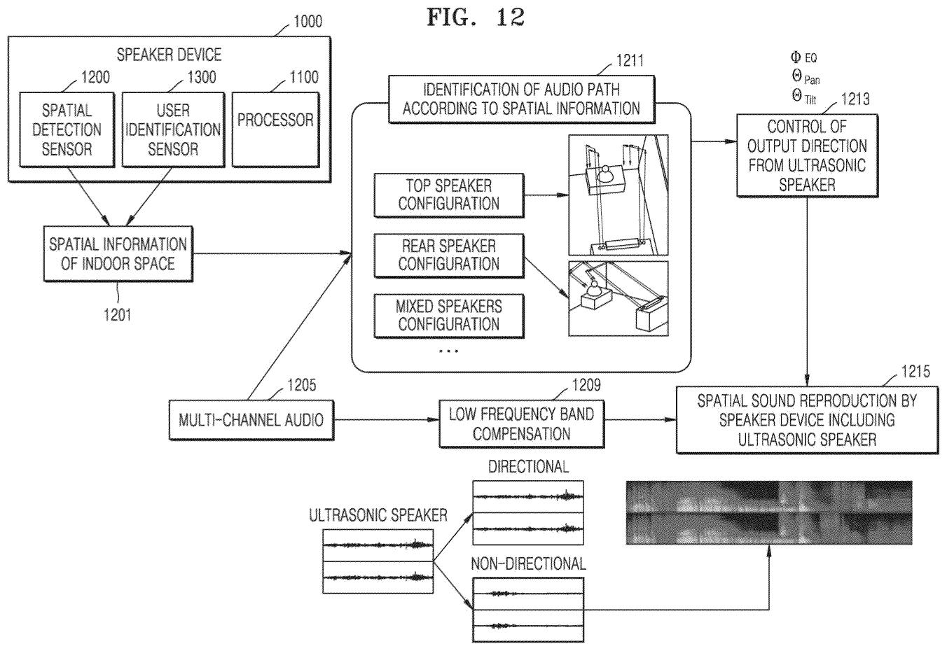

FIG. 12 is a diagram illustrating a spatial sound effect generated by a speaker device including an ultrasonic speaker, according to an embodiment of the disclosure.

Referring to FIG. 12, by the ultrasonic speaker 1500 included in the speaker device 1000 according to an embodiment of the disclosure, the spatial sound effect is generated without a spatial sound effect generation speaker.

The speaker device 1000 according to an embodiment of the disclosure may include the front speaker 1400, the ultrasonic speaker 1500 for delivering, for a spatial sound effect, an audio signal via reflection in an indoor space, and the spatial detection sensor 1200 for obtaining spatial information of the indoor space in which a user is positioned. Also, the speaker device 1000 according to an embodiment of the disclosure may include a processor 1100. The processor 1100 may include a plurality of processors. With reference to FIG. 12, the speaker device 1000 is briefly described, and a configuration of the speaker device 1000 will be described in detail below with a block diagram.

In operation 1201, spatial information of an indoor space in which a user is positioned is obtained via the spatial detection sensor 1200. According to an embodiment of the disclosure, the spatial detection sensor 1200 may be included in the speaker device 1000 or may be included in a separate external electronic device. When the spatial detection sensor 1200 is not included in the speaker device 1000 but is included in the separate external electronic device, the speaker device 1000 may receive, via communication from the external electronic device, spatial information obtained by the external electronic device via the spatial detection sensor 1200. According to an embodiment of the disclosure, the spatial detection sensor 1200 may detect information of at least one of an area, a length, or a height of the indoor space. In order to detect the information of at least one of the area, the length, or the height of the indoor space, the spatial detection sensor 1200 may include a depth measurement sensor capable of detecting the depth of the indoor space. According to an embodiment of the disclosure, based on the spatial detection sensor 1200 detecting the information of at least one of the area, the length, or the height of the indoor space, information about a shape of the indoor space may also be detected. For example, it may be identified, based on information detected by the spatial detection sensor 1200, whether the shape of the indoor space is a rectangular shape, a round shape, an irregular polygonal shape, etc.

According to an embodiment of the disclosure, the spatial information may also include position information of the user. In operation 1201, the speaker device 1000 may identify a position of the user via the user identification sensor 1300. The user identification sensor 1300 may be included in the speaker device 1000 or may be included in an external electronic device. When the user identification sensor 1300 is included in the external electronic device, the speaker device 1000 may receive, from the external electronic device, position information of the user which is obtained via the user identification sensor 1300. The user identification sensor 1300 may include a sensor for detecting a person and a sensor for detecting a position at which the person is present. The sensor for detecting a person and/or the sensor for detecting a position at which the person is present may include at least one of an IR sensor, an ultrasonic sensor, a microwave (radar) sensor, a camera-based sensor, or a real-time position tracking sensor.

When the spatial information of the indoor space is obtained by the spatial detection sensor 1200, the processor 1100 may store numerical values corresponding to a width, a length (depth) and/or a height of the indoor space, based on the spatial information of the indoor space. For example, based on the spatial information obtained by the spatial detection sensor 1200, numerical values of 4 m as the width of the indoor space, 6 m as the length, and 2.5 m as the height may be stored in the memory of the speaker device 1000. The numerical values corresponding to the indoor space, based on the spatial information, may be used in identification of a path of an audio signal output from the ultrasonic speaker 1500.

In operation 1205, according to an embodiment of the disclosure, the processor 1100 analyzes an audio signal to be output, and thus, identifies a channel corresponding to the audio signal.

For example, when channels of the audio signal are 5.1, based on a result of analyzing, by the processor 1100, the audio signal to be output, a full bandwidth channel of 20 Hz to 20 kHz and 1 low frequency channel (0.1 channel of 20 Hz to 80 Hz) are used for the audio signal. In order for the speaker device 1000 to cover frequency ranges of the audio signal corresponding to 5.1, the speaker device 1000 has to include a front center speaker C, a front left speaker L, a front right speaker R, a surround left speaker LS, a surround right speaker RS, and a subwoofer.

Therefore, according to an embodiment of the disclosure, the processor 1100 may determine, based on the analyzed audio signal, which channel to allocate to the ultrasonic speaker 1500 in response to the audio signal. When the audio signal has an audio signal (component) to be output via a rear speaker, based on the analyzed audio signal, the ultrasonic speaker 1500 may operate to output the audio signal (component). Therefore, according to an embodiment of the disclosure, the processor 1100 may determine which channel of the audio signal to allocate to the ultrasonic speaker 1500, based on a channel corresponding to the analyzed audio signal.

When the channels of the audio signal to be output are 5.1, based on the result of analyzing, by the processor 1100, the processor 1100 may determine the ultrasonic speaker 1500 to be substituted for the surround left speaker LS and the surround right speaker RS. The surround left speaker LS and the surround right speaker RS may all be side speakers. In other words, the processor 1100 may allow the ultrasonic speaker 1500 to be substituted for the surround left speaker LS and the surround right speaker RS.

According to an embodiment of the disclosure, when the processor 1100 allocates the ultrasonic speaker 1500 to a speaker corresponding to a channel for a spatial sound effect, the processor 1100 may perform allocation in order of a rear speaker, a side speaker, and a top speaker.

In operation 1209, according to an embodiment of the disclosure, the processor 1100 may include a non-directional low frequency signal in a first audio signal to be output from the front speaker 1400, the non-directional low frequency signal being equal to or less than a preset frequency and being of a spatial effect audio signal included in the audio signal to be output from the speaker device 1000. The preset frequency may be, for example, 400 Hz. Obviously, this is merely an embodiment of the disclosure, and the preset frequency may be greater or less than 400 Hz. By doing so, the processor 1100 of the speaker device 1000 may compensate for a low-frequency band of the spatial effect audio signal.

According to an embodiment of the disclosure, the processor 1100 may identify, as a second audio signal, a signal of a frequency greater than the preset frequency, the signal being of the spatial effect audio signal included in the audio signal to be output. The preset frequency may be, for example, 400 Hz. Obviously, this is merely an embodiment of the disclosure, and the preset frequency may be greater or less than 400 Hz. The second audio signal is a signal that is of the spatial effect audio signal, is equal to or less than the preset frequency, and excludes the non-directional low frequency signal.

In operation 1211, according to an embodiment of the disclosure, the processor 1100 may identify a path of the second audio signal to be output from the ultrasonic speaker 1500, based on 1) the spatial information and 2) to which spatial sound speaker the ultrasonic speaker 1500 is allocated, according to a channel corresponding to the audio signal. The second audio signal output from the ultrasonic speaker 1500 may reach the user via reflection from a wall surface forming the indoor space. According to an embodiment of the disclosure, the path of the second audio signal may be identified by using a reflection characteristic of the ultrasonic speaker 1500 and the Monte-Carlo Ray Tracing algorithm, but the disclosure is not limited thereto. For example, according to the identified path, the second audio signal may be delivered to the user from the rear, the side, or the ceiling (the top of the indoor space) of the user. In this manner, the ultrasonic speaker 1500 allows the second audio signal to be reflected from the wall surface of the indoor space and then to reach the user, and thus, may generate an effect in which any one speaker of a rear speaker, a side speaker, or a top speaker operates, even when the speaker device 1000 does not include the rear speaker, the side speaker, or the top speaker.

According to an embodiment of the disclosure, the processor 1100 may identify a path of an audio signal related to the spatial sound effect in the indoor space, based on the spatial information. Also, according to an embodiment of the disclosure, the processor 1100 may identify the path of the second audio signal to be output from the ultrasonic speaker 1500, based on to which spatial sound speaker the ultrasonic speaker 1500 is allocated, by comparing the channel corresponding to the audio signal and speaker channels of the speaker device 1000. Also, the path of the second audio signal output from the ultrasonic speaker 1500 may be changed based on a position of the user which is detected by the user identification sensor 1300. For example, the user identification sensor 1300 may periodically determine a position of the user, and when a position of the user is changed, the processor 1100 may change the path of the second audio signal.

When it is determined that the ultrasonic speaker 1500 is to be substituted for a rear speaker, a directivity direction of the ultrasonic speaker 1500 is changed to allow the second audio signal to be delivered from the both rear sides of the user. In this regard, a side directivity direction of the ultrasonic speaker 1500 may vary according to a width of the indoor space based on the spatial information. For example, when it is assumed that a distance between the speaker device 1000 and the user is constant, the greater the width of the indoor space is, the greater a side directivity angle of the ultrasonic speaker 1500 is. Also, when a length of the indoor space is long and the width is small, the side directivity angle of the ultrasonic speaker 1500 may decrease.

For example, when it is determined that the ultrasonic speaker 1500 is to be substituted for a top speaker, a directivity direction of the ultrasonic speaker 1500 is determined to allow the second audio signal to be delivered from the top of the user. In this regard, a top directivity direction of the ultrasonic speaker 1500 may vary according to a height of the indoor space based on the spatial information. For example, when it is assumed that a distance between the speaker device 1000 and the user is constant, the greater the height is, the greater a top directivity angle of the ultrasonic speaker 1500 is.

For example, when it is determined that the ultrasonic speaker 1500 is to be substituted for a side speaker, a directivity direction of the ultrasonic speaker 1500 is determined to allow the second audio signal to be delivered from the side of the user. When it is determined that the ultrasonic speaker 1500 is to be substituted for the side speaker, not the rear speaker, the side directivity angle of the ultrasonic speaker 1500 becomes greater than a case in which the ultrasonic speaker 1500 is substituted for the rear speaker.

In operation 1213, according to an embodiment of the disclosure, the processor 1100 may control a directivity direction of the ultrasonic speaker 1500 to be changed by controlling the tilt motor 1510 and the pan motor 1520 of the speaker device 1000, according to the determined directivity direction of the ultrasonic speaker 1500. The tilt motor 1510 is a motor that operates to change an up and down angle Θₜᵢₗₜ of the ultrasonic speaker 1500, and the pan motor 1520 is a motor that operates to change a left and right angle Θₚₐₙ of the ultrasonic speaker 1500.

According to an embodiment of the disclosure, the processor 1100 may selectively set EQ φ_{EQ} with respect to the ultrasonic speaker 1500, based on the spatial information. The processor 1100 may set optimal EQ according to a user's environment by recognizing a distance between the speaker device 1000 and the user, distances between respective speakers in the speaker device 1000, a level between channels, and a frequency characteristic.

In operation 1215, according to an embodiment of the disclosure, the processor 1100 may control the second audio signal to be output via the ultrasonic speaker 1500 in the directivity direction determined by the tilt motor 1510 and the pan motor 1520. Also, the processor 1100 may output, via the front speaker 1400, the first audio signal that is of the spatial effect audio signal included in the audio signal, is equal to or less than a preset frequency, and includes a non-directional low frequency signal. The user (listener) may experience a spatial sound effect via the second audio signal that is output from the ultrasonic speaker 1500 and then is reflected from a wall surface so as to generate the spatial sound effect and includes a directional audio signal, without a separate spatial sound effect generation speaker such as a rear speaker, a side speaker, or a top speaker.

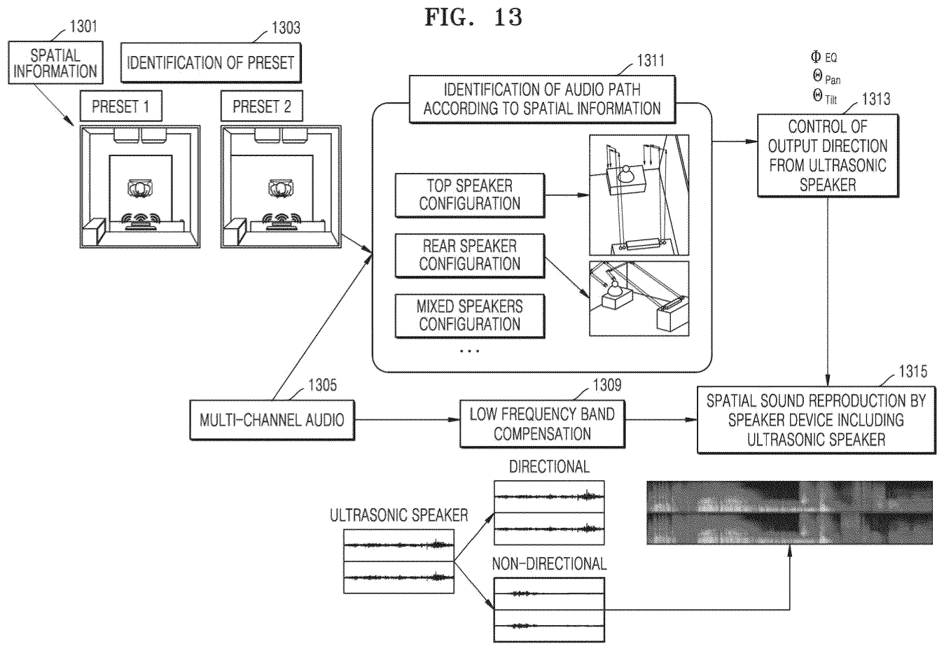

FIG. 13 is a diagram illustrating a spatial sound effect generated by a speaker device including an ultrasonic speaker, according to an embodiment of the disclosure.

Referring to FIG. 13, it is shown that the spatial sound effect is generated by the ultrasonic speaker 1500 included in the speaker device 1000 according to an embodiment of the disclosure, without a spatial sound effect generation speaker.

As in FIG. 12, the speaker device 1000 according to an embodiment of the disclosure may include the front speaker 1400, the ultrasonic speaker 1500 for delivering, for a spatial sound effect, an audio signal via reflection in an indoor space, and the spatial detection sensor 1200 for selectively obtaining spatial information of the indoor space in which a user is positioned. Also, the speaker device 1000 according to an embodiment of the disclosure may include a processor 1100. The processor 1100 may include a plurality of processors.

In operation 1301, the speaker device 1000 according to an embodiment of the disclosure obtains spatial information. According to an embodiment of the disclosure, a method by which the speaker device 1000 obtains spatial information may include 1) obtaining, via the spatial detection sensor 1200, spatial information of an indoor space in which a user is positioned, or 2) obtaining spatial information by a user input.

According to an embodiment of the disclosure, the spatial information may not be detected by the spatial detection sensor 1200 but may be replaced by at least one of a plurality of pieces of preset information included in the speaker device 1000. For example, when the speaker device 1000 does not include the spatial detection sensor 1200 or the spatial detection sensor 1200 does not operate, a user or the processor of the speaker device 1000 may select preset information that is most relevant to an indoor space in which a user is currently positioned and is from among a plurality of pieces of preset information stored in a memory of the speaker device 1000 and corresponding to a plurality of pieces of spatial information. An embodiment of the disclosure in which spatial information is obtained by the spatial detection sensor 1200 is already described with reference to FIG. 12, and thus, redundant descriptions thereof are not provided here.

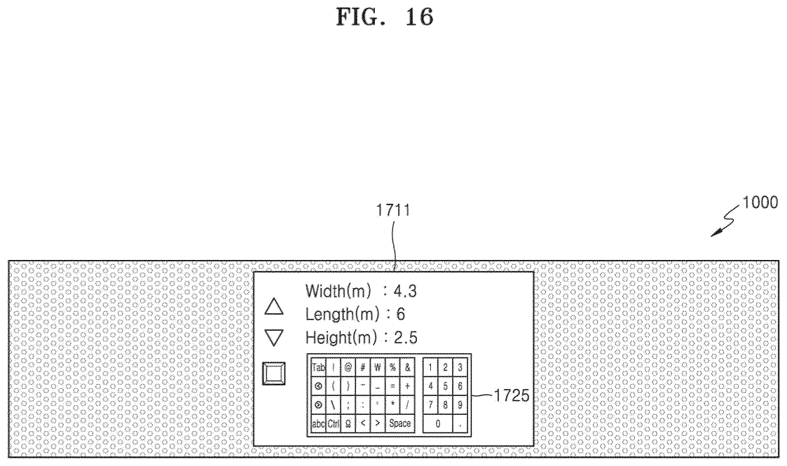

According to an embodiment of the disclosure, the spatial information may be obtained by inputting, by a user, indoor spatial information to the speaker device 1000. The user may directly input values corresponding to the spatial information to the speaker device 1000, or may input the values to a mobile device via communication. With reference to FIG. 16, a method of inputting, by a user, values corresponding to spatial information will now be described.

FIG. 16 is a diagram illustrating an example of inputting an indoor space size to a speaker device, according to an embodiment of the disclosure.

Referring to FIG. 16, a user may directly input an indoor space size (width 4.3 m, length 6 m, and height 2.5 m) via a touch keypad 1725 that is a type of an input interface displayed on a screen of an indoor space size input mode on a display 1711 of the speaker device 1000.

FIG. 16 illustrates the example in which the user directly inputs information related to the indoor space size to the display 1711 of the speaker device 1000, but the speaker device 1000 may receive information related to the indoor space size from an external electronic device. For example, the user may input the information related to the indoor space size via the mobile device, and when communication between the mobile device and the speaker device 1000 is established, the speaker device 1000 may receive the information related to the indoor space size from the mobile device that is the external electronic device.

Description will be continued with reference to FIG. 13.

When the spatial information is obtained, in operation 1303, based on the input indoor space size corresponding to the spatial information, according to an embodiment of the disclosure, the processor 1100 of the speaker device 1000 may automatically select preset information that has the smallest deviation from the input indoor space size and is from among the plurality of pieces of preset information stored in the speaker device 1000.

According to an embodiment of the disclosure, the speaker device 1000 may obtain the spatial information according to the information related to the indoor space size which is input by the user. In operation 1303, the speaker device 1000 may not select any one of the plurality of pieces of preset information, according to the spatial information, and may changelessly use, as the spatial information, the information related to the indoor space size which is input by the user. Therefore, in this case, the spatial information according to the information related to the indoor space size which is input by the user may be changelessly used in operation 1313.

According to an embodiment of the disclosure, the speaker device 1000 may further include a memory 1800, and a plurality of pieces of preset information corresponding to various indoor spaces may be stored in the memory 1800. A plurality of different indoor spaces may respectively correspond to a plurality of pieces of spatial information, and the plurality of pieces of spatial information may respectively correspond to the plurality of pieces of preset information. In other words, spatial information about the various indoor spaces may be pre-stored as preset information in the memory 1800 of the speaker device 1000.

When the processor 1100 of the speaker device 1000 selects the preset information that has the smallest deviation from the indoor space size input by the user and is from among the plurality of pieces of preset information, as described with reference to FIG. 16, the processor 1100 may select the preset information having the smallest deviation from the input indoor space size by applying the same weight to the width, the length, and the height. Alternatively, the processor 1100 of the speaker device 1000 may select the preset information having the smallest deviation from the input indoor space size by applying a weight to a particular value among the width, the length, and the height. For example, when a ‘height’ of an indoor space is not an important factor in selection of preset information, the speaker device 1000 may compare the plurality of pieces of preset information with the input indoor space size by applying a great weight to a width and a length and applying a small weight to the height. For example, when calculating a deviation between the input indoor space size and preset information, the deviation may be calculated by applying 3 to the width, applying 3 to the length, and applying 0.1 to the height.

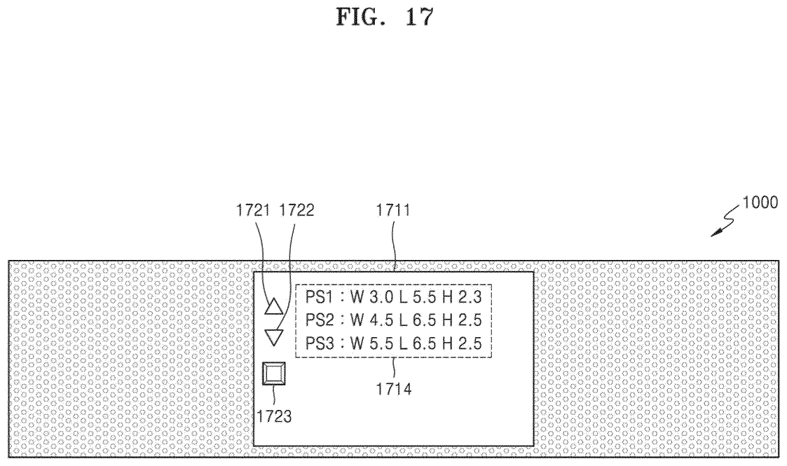

The processor 1100 may select appropriate preset information among the plurality of pieces of preset information, or, according to an embodiment of the disclosure, a user may select preset information corresponding to the spatial information among the plurality of pieces of preset information. FIG. 17 will now be briefly referred to.

Referring to FIG. 17, the speaker device 1000 may display a preset list 1714 on the display 1711 that is a type of an output interface. Referring to FIG. 17, while the preset list 1714 displays preset 1 PS1, preset 2 PS2, and preset 3 PS3, the preset list 1714 may display more or fewer presets than the shown presets. The user may perform movement between the plurality of pieces of preset information by using an upward movement button 1721 and a downward movement button 1722. The preset list 1714 may also display indoor space values included in each preset. For example, preset 1 PS1 corresponds to the width of 3.0 m, the length of 5.5 m, and the height of 2.3 m. According to determination by the user, when a current indoor space is most relevant to preset 2 PS2, the user may perform movement to preset 2 PS2 by using the upward movement button 1721 and the downward movement button 1722, and then may select preset 2 PS2 by using a selection button 1723.

Description will be continued with reference to FIG. 13.

The spatial information according to an embodiment of the disclosure may also include position information of the user. That the position information of the user is obtained by the user identification sensor 1300 is already described with reference to FIG. 12, and thus, redundant descriptions thereof are not provided here.

In operation 1303, according to an embodiment of the disclosure, the preset information may include an audio signal for generating a spatial sound effect and may also include path information of the audio signal for generating the spatial sound effect. Therefore, when the spatial information is determined, the processor 1100 of the speaker device 1000 does not need to separately calculate a path of the audio signal for generating the spatial sound effect, may identify, from the pre-stored preset information, the path of the audio signal for generating the spatial sound effect, and may perform directivity control of the ultrasonic speaker 1500.

In operation 1305, according to an embodiment of the disclosure, the processor 1100 may analyze an audio signal to be output, and thus, may identify a speaker corresponding to a spatial sound effect among channels corresponding to the audio signal. The processor 1100 allocates the ultrasonic speaker 1500 to the identified speaker corresponding to the spatial sound effect.

For example, when channels of the audio signal are 5.1, according to a result of analyzing the audio signal to be output, the speaker device 1000 may allocate the ultrasonic speaker 1500 to the surround left speaker LS and the surround right speaker RS for the spatial sound effect corresponding to the 5.1 channels.

In operation 1309, according to an embodiment of the disclosure, the processor 1100 may include a non-directional low frequency signal of a spatial effect audio signal in a first audio signal to be output from the front speaker 1400, the non-directional low frequency signal being equal to or less than a preset frequency and the spatial effect audio signal being included in an audio signal to be output from the speaker device 1000. The preset frequency may be, for example, 400 Hz. Obviously, this is merely an embodiment of the disclosure, and the preset frequency may be greater or less than 400 Hz. In this manner, the processor 1100 of the speaker device 1000 may compensate for a low frequency band of the spatial effect audio signal.

According to an embodiment of the disclosure, the speaker device 1000 may identify a signal of a frequency greater than a preset frequency as a second audio signal, the signal being of a spatial effect audio signal included in an audio signal to be output. The preset frequency may be, for example, 400 Hz. Obviously, this is merely an embodiment of the disclosure, and the preset frequency may be greater or less than 400 Hz. The second audio signal is a signal of the spatial effect audio signal, the signal excluding a non-directional low frequency signal and being equal to or less than the preset frequency.

In operation 1311, according to an embodiment of the disclosure, the processor 1100 may identify a path of the second audio signal output from the ultrasonic speaker 1500, according to the preset information selected based on the spatial information, and to which spatial effect speaker the ultrasonic speaker 1500 is allocated. The second audio signal output from the ultrasonic speaker 1500 may reach the user via reflection from a wall surface forming the indoor space. According to an embodiment of the disclosure, the path of the second audio signal may be identified by using a reflection characteristic of the ultrasonic speaker 1500 and the Monte-Carlo Ray Tracing algorithm, but the disclosure is not limited thereto. For example, according to the identified path, the second audio signal may be delivered to the user from the rear, the side, or the ceiling (the top of the indoor space) of the user. In this manner, the ultrasonic speaker 1500 allows the second audio signal to be reflected from the wall surface of the indoor space and then to reach the user, and thus, may generate a spatial sound effect that may be generated by a rear speaker, a side speaker, or a top speaker, even when the speaker device 1000 does not include the rear speaker, the side speaker, or the top speaker.

According to an embodiment of the disclosure, the processor 1100 may identify a path of an audio signal related to the spatial sound effect in the indoor space, based on the preset information selected based on the spatial information. Also, according to an embodiment of the disclosure, the processor 1100 may identify the path of the second audio signal output from the ultrasonic speaker 1500, based on to which spatial effect speaker the ultrasonic speaker 1500 is allocated. When it is determined that the ultrasonic speaker 1500 is to be substituted for the side speaker, a directivity direction of the ultrasonic speaker 1500 may be determined to allow the second audio signal to be delivered from both sides of the user.

For example, when it is determined that the ultrasonic speaker 1500 is to be substituted for the top speaker, a directivity direction of the ultrasonic speaker 1500 may be determined to allow the second audio signal to be delivered from the top of the user. In this regard, the directivity direction of the ultrasonic speaker 1500 in an upward direction may vary according to a height of the indoor space based on the spatial information.

In operation 1313, according to an embodiment of the disclosure, the processor 1100 may control a directivity direction of the ultrasonic speaker 1500 by controlling the tilt motor 1510 and the pan motor 1520 of the speaker device 1000, according to a determined directivity direction of the ultrasonic speaker 1500. The tilt motor 1510 is a motor that operates to change an up and down angle Θₜᵢₗₜ of the ultrasonic speaker 1500, and the pan motor 1520 is a motor that operates to change a left and right angle Θₚₐₙ of the ultrasonic speaker 1500.

According to an embodiment of the disclosure, the processor 1100 may set EQ φ_{EQ} with respect to the ultrasonic speaker 1500, based on the spatial information. Via the EQ setting, sound of a particular frequency band of the audio may be emphasized or decreased, such that a desired tone and sound quality may be generated. The processor 1100 may set optimal EQ according to a user's environment by recognizing a distance between the speaker device 1000 and a user, distances between respective speakers in the speaker device 1000, a level between channels, and a frequency characteristic.

In operation 1315, according to an embodiment of the disclosure, the processor 1100 may control the second audio signal to be output via the ultrasonic speaker 1500 facing the directivity direction by the tilt motor 1510 and the pan motor 1520. Also, the processor 1100 may output, via the front speaker 1400, the first audio signal that is of the spatial effect audio signal included in the audio signal, is equal to or less than a preset frequency, and includes a non-directional low frequency signal. The user (listener) may experience a spatial sound effect via the second audio signal that is output from the ultrasonic speaker 1500 and then is reflected from a wall surface so as to generate the spatial sound effect, without a separate spatial sound effect generation speaker such as a rear speaker, a side speaker, or a top speaker.

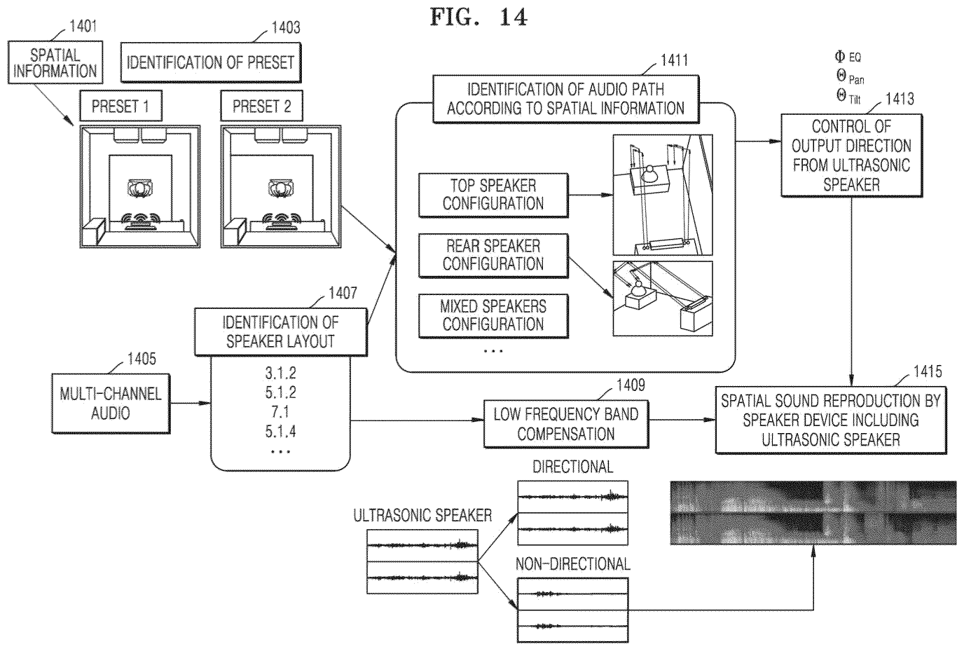

FIG. 14 is a diagram illustrating a spatial sound effect generated by a speaker device including an ultrasonic speaker, according to an embodiment of the disclosure.

Referring to FIG. 14, it is shown that the spatial sound effect is generated by the ultrasonic speaker 1500 included in the speaker device 1000 according to an embodiment of the disclosure, without a spatial sound effect generation speaker.

The speaker device 1000 according to an embodiment of the disclosure may include the front speaker 1400, the ultrasonic speaker 1500 for delivering, for a spatial sound effect, an audio signal via reflection in an indoor space, and the spatial detection sensor 1200 for selectively obtaining spatial information of the indoor space in which a user is positioned. Also, the speaker device 1000 according to an embodiment of the disclosure may include a processor 1100. The processor 1100 may include a plurality of processors.

In operation 1401, spatial information of an indoor space in which a user is positioned is obtained via the spatial detection sensor 1200, or by a user input. According to an embodiment of the disclosure, when the spatial information is not detected by the spatial detection sensor 1200, the spatial information may be replaced by at least one of a plurality of pieces of preset information stored in the memory of the speaker device 1000. For example, when the speaker device 1000 does not include the spatial detection sensor 1200 or the spatial detection sensor 1200 does not operate, the user or the processor 1100 may select any one of the plurality of pieces of preset information stored in the memory of the speaker device 1000 and corresponding to a plurality of pieces of spatial information. Preset information selection is already described with reference to FIGS. 12 and 13, and thus, redundant descriptions thereof are not provided here.

In operation 1403, according to an embodiment of the disclosure, the user or the processor 1100 may determine the preset information, based on the spatial information obtained in operation 1401. An embodiment of the disclosure in which the preset information is selected is already described with reference to operation 1303 of FIG. 13, and thus, redundant descriptions thereof are not provided here.

The processor 1100 may select appropriate preset information among the plurality of pieces of preset information, or, according to an embodiment of the disclosure, a user may select preset information corresponding to the spatial information among the plurality of pieces of preset information. This is already described with reference to FIG. 17, and thus, redundant descriptions thereof are not provided here.

According to an embodiment of the disclosure, the spatial information may include position information of the user. That the position information of the user is obtained via the user identification sensor 1300 is already described with reference to FIG. 12, and thus, redundant descriptions thereof are not provided here.

According to an embodiment of the disclosure, the preset information may also include path information of an audio signal for generating a spatial sound effect. Therefore, according to an embodiment of the disclosure, when the spatial information is determined, the processor 1100 does not need to separately calculate a path of the audio signal for generating the spatial sound effect, may identify, from the pre-stored preset information, the path of the audio signal for generating the spatial sound effect, and may perform directivity control of the ultrasonic speaker 1500.

In operation 1405, according to an embodiment of the disclosure, the processor 1100 may analyze an audio signal to be output, and thus, may identify channels corresponding to the audio signal. In operation 1407, the processor 1100 may identify speaker channels (speaker layout) of the speaker device 1000, and may compare the identified channels corresponding to the audio signal with the speaker channels (speaker layout) of the speaker device 1000.

For example, when channels of the audio signal are 5.1, based on a result of analyzing, by the processor 1100, the audio signal to be output, a full bandwidth channel of 20 Hz to 20 kHz and 1 low frequency channel (0.1 channel of 20 Hz to 80 Hz) are used for the audio signal. In order for the speaker device 1000 to cover frequency ranges of the audio signal corresponding to 5.1, the speaker device 1000 has to include a front center speaker C, a front left speaker L, a front right speaker R, a surround left speaker LS, a surround right speaker RS, and a subwoofer.

In operation 1407, according to an embodiment of the disclosure, the processor 1100 may identify the speaker channels (speaker layout) of the speaker device 1000, and may determine whether the speaker device 1000 is capable of covering all 5.1 channels corresponding to the audio signal. Speaker channels refer to information about a configuration of speakers for each frequency range included in the speaker device 1000. As in the example above, when the speaker device 1000 includes the front center speaker C, the front left speaker L, the front right speaker R, the surround left speaker LS, the surround right speaker RS, and the subwoofer, the speaker channels of the speaker device 1000 may be 5.1. When the speaker device 1000 includes only the front center speaker C, the front left speaker L, the front right speaker R, and the subwoofer, the speaker channels of the speaker device 1000 may be 3.1. Information about the speaker channels may be pre-stored in the memory 1800 of the speaker device 1000.

According to an embodiment of the disclosure, the processor 1100 may compare channels corresponding to an audio signal with the speaker channels of the speaker device 1000, and may determine to which channel the ultrasonic speaker 1500 is to be allocated—which channel has to be substituted with the ultrasonic speaker 1500.

As a result of the analysis performed by the processor 1100, when the channels of the audio signal to be output are 5.1 and the speaker channels of the speaker device 1000 are 3.1—in other words, when the speaker device 1000 includes only the front center speaker C, the front left speaker L, the front right speaker R, and the subwoofer, according to an embodiment of the disclosure, the processor 1100 may determine that the ultrasonic speaker 1500 is to be substituted for the surround left speaker LS and the surround right speaker RS. In other words, the processor 1100 may allocate the ultrasonic speaker 1500 to the surround left speaker LS and the surround right speaker RS.

According to an embodiment of the disclosure, when the processor 1100 compares channels corresponding to an audio signal to be output with the speaker channels of the speaker device 1000, and determines for which channel the ultrasonic speaker 1500 is to be substituted—to which channel the ultrasonic speaker 1500 is to be allocate, the processor 1100 may allow the ultrasonic speaker 1500 to be primarily substituted for a speaker (e.g., spatial sound effect speaker) that corresponds to a channel for a spatial sound effect. The speaker that corresponds to the channel for the spatial sound effect may include at least one of a rear speaker, a side speaker, or a top speaker.

According to an embodiment of the disclosure, when the processor 1100 allocates the ultrasonic speaker 1500 to a speaker corresponding to the channel for the spatial sound effect among channels not included in the speaker device 1000, the processor 1100 may allocate the ultrasonic speaker 1500 to the speaker in order of the rear speaker, the side speaker, and the top speaker.

In operation 1409, according to an embodiment of the disclosure, the processor 1100 may include a non-directional low frequency signal in a first audio signal to be output from the front speaker 1400, the non-directional low frequency signal being equal to or less than a preset frequency and being of a spatial effect audio signal included in the audio signal to be output from the speaker device 1000. The preset frequency may be, for example, 400 Hz. Obviously, this is merely an embodiment of the disclosure, and the preset frequency may be greater or less than 400 Hz. By doing so, the processor 1100 of the speaker device 1000 may compensate for a low-frequency band of the spatial effect audio signal.

According to an embodiment of the disclosure, the processor 1100 may identify, as a second audio signal, a signal of a frequency greater than the preset frequency, the signal being of the spatial effect audio signal included in the audio signal to be output. The preset frequency may be, for example, 400 Hz. Obviously, this is merely an embodiment of the disclosure, and the preset frequency may be greater or less than 400 Hz. The second audio signal is a signal that is of the spatial effect audio signal, is equal to or less than the preset frequency, and excludes the non-directional low frequency signal.

In operation 1411, according to an embodiment of the disclosure, the processor 1100 may identify a path of the second audio signal to be output from the ultrasonic speaker 1500, according to preset information selected based on the spatial information, and to which spatial sound speaker the ultrasonic speaker 1500 is to be allocated, based on comparison between channels corresponding to the audio signal and the speaker channels of the speaker device 1000. The second audio signal output from the ultrasonic speaker 1500 may reach the user via reflection from a wall surface forming the indoor space. According to an embodiment of the disclosure, the path of the second audio signal may be identified by using a reflection characteristic of the ultrasonic speaker 1500 and the Monte-Carlo Ray Tracing algorithm, but the disclosure is not limited thereto. For example, according to the identified path, the second audio signal may be delivered to the user from the rear, the side, or the ceiling (the top of the indoor space) of the user. In this manner, the ultrasonic speaker 1500 allows the second audio signal to be reflected from the wall surface of the indoor space and then to reach the user, and thus, may generate the same effect as that an audio signal is generated in a direction of at least one of the rear speaker, the side speaker, or the top speaker, even when the speaker device 1000 does not include the rear speaker, the side speaker, or the top speaker.

According to an embodiment of the disclosure, the processor 1100 may identify a path of an audio signal related to the spatial sound effect in the indoor space, based on the preset information selected based on the spatial information. Also, according to an embodiment of the disclosure, the processor 1100 may identify the path of the second audio signal to be output from the ultrasonic speaker 1500, based on to which spatial sound speaker the ultrasonic speaker 1500 is allocated, by comparing the channel corresponding to the audio signal and speaker channels of the speaker device 1000. When it is determined that the ultrasonic speaker 1500 is to be substituted for a rear speaker, a directivity direction of the ultrasonic speaker 1500 is changed to allow the second audio signal to be delivered from the both rear sides of the user. In this regard, a side directivity direction of the ultrasonic speaker 1500 may vary according to a width of the indoor space based on the spatial information. For example, when it is assumed that a distance between the speaker device 1000 and the user is constant, the greater the width of the indoor space is, the greater a side directivity angle of the ultrasonic speaker 1500 is. Also, when a length of the indoor space is long and the width is small, the side directivity angle of the ultrasonic speaker 1500 may decrease.

For example, when it is determined that the ultrasonic speaker 1500 is to be substituted for a top speaker, a directivity direction of the ultrasonic speaker 1500 is determined to allow the second audio signal to be delivered from the top of the user. In this regard, a top directivity direction of the ultrasonic speaker 1500 may vary according to a height of the indoor space based on the spatial information. For example, when it is assumed that a distance between the speaker device 1000 and the user is constant, the greater the height is, the greater a top directivity angle of the ultrasonic speaker 1500 is.

As another example, when it is determined that the ultrasonic speaker 1500 is to be substituted for a side speaker, a directivity direction of the ultrasonic speaker 1500 is determined to allow the second audio signal to be delivered from the side of the user. When it is determined that the ultrasonic speaker 1500 is to be substituted for the side speaker, not the rear speaker, the side directivity angle of the ultrasonic speaker 1500 becomes greater than a case in which the ultrasonic speaker 1500 is substituted for the rear speaker.

In operation 1413, according to an embodiment of the disclosure, the processor 1100 may control a directivity direction of the ultrasonic speaker 1500 to be changed by controlling the tilt motor 1510 and the pan motor 1520 of the speaker device 1000, according to the determined directivity direction of the ultrasonic speaker 1500. The tilt motor 1510 is a motor that operates to change an up and down angle Θₜᵢₗₜ of the ultrasonic speaker 1500, and the pan motor 1520 is a motor that operates to change a left and right angle Θₚₐₙ of the ultrasonic speaker 1500.

According to an embodiment of the disclosure, the processor 1100 may set EQ φ_{EQ} with respect to the ultrasonic speaker 1500, based on the spatial information. EQ setting of audio may refer to a procedure for individually adjusting sound by adjusting a frequency response of an audio signal. Via the EQ setting, sound of a particular frequency band of the audio signal may be emphasized or decreased, such that a desired tone and sound quality may be generated. In other words, filtering of a particular frequency range may be performed according to the EQ setting. The processor 1100 may set optimal EQ according to a user's environment by recognizing a distance between the speaker device 1000 and a user, distances between respective speakers in the speaker device 1000, a level between channels, and a frequency characteristic.

In operation 1415, according to an embodiment of the disclosure, the processor 1100 may control the second audio signal to be output via the ultrasonic speaker 1500 facing the directivity direction by the tilt motor 1510 and the pan motor 1520. Also, the processor 1100 outputs, via the front speaker 1400, the first audio signal that is of the spatial effect audio signal included in the audio signal, is equal to or less than a preset frequency, and includes a non-directional low frequency signal. The user (listener) may experience a spatial sound effect via the second audio signal that is output from the ultrasonic speaker 1500 and then is reflected from a wall surface so as to generate the spatial sound effect, without a separate spatial sound effect generation speaker such as the rear speaker, the side speaker, or the top speaker.

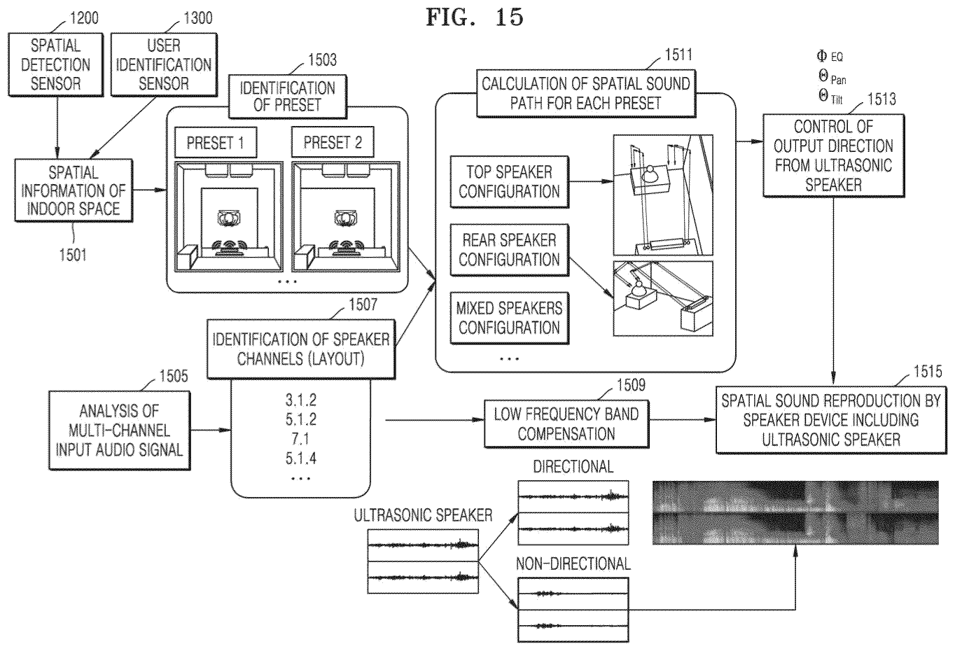

FIG. 15 is a diagram illustrating a spatial sound effect generated by a speaker device including an ultrasonic speaker, according to an embodiment of the disclosure.

Referring to FIG. 15, it is shown that the spatial sound effect is generated by the ultrasonic speaker 1500 included in the speaker device 1000 according to an embodiment of the disclosure, without a spatial sound effect generation speaker.

The speaker device 1000 according to an embodiment of the disclosure may include the front speaker 1400, the ultrasonic speaker 1500 for delivering, for a spatial sound effect, an audio signal via reflection in an indoor space, and the spatial detection sensor 1200 for selectively obtaining spatial information of the indoor space in which a user is positioned. Also, the speaker device 1000 according to an embodiment of the disclosure may include a processor 1100. The processor 1100 may include a plurality of processors.

In operation 1501, spatial information of an indoor space in which the user is positioned is obtained via the spatial detection sensor 1200. The spatial detection sensor 1200 may be included in the speaker device 1000 or may be included in an external electronic device. When the spatial detection sensor 1200 is not included in the speaker device 1000 but is separately included in the external electronic device, the speaker device 1000 may receive, from the external electronic device, spatial information obtained by the external electronic device via the spatial detection sensor 1200. According to an embodiment of the disclosure, based on the spatial detection sensor 1200 detecting the information of at least one of the area, the length, or the height of the indoor space, information about a shape of the indoor space may also be detected. For example, it may be identified, based on information detected by the spatial detection sensor 1200, whether the shape of the indoor space is a rectangular shape, a round shape, an irregular polygonal shape, etc.

According to an embodiment of the disclosure, preset information corresponding to the obtained spatial information may be selected. Alternatively, according to an embodiment of the disclosure, the spatial information may not be detected by the spatial detection sensor 1200 but may be replaced by at least one of a plurality of pieces of preset information included in the speaker device 1000. For example, when the speaker device 1000 does not include the spatial detection sensor 1200 or the spatial detection sensor 1200 does not operate, the user may select preset information that is most relevant to an indoor space in which a user is currently positioned and is from among a plurality of pieces of preset information stored in a memory of the speaker device 1000 and corresponding to a plurality of pieces of spatial information. This will be described in detail with reference to operation 1503.

In operation 1503, according to an embodiment of the disclosure, the processor 1100 may determine preset information, based on the spatial information obtained in operation 1501. The speaker device 1000 may further include the memory 1800, and a plurality of pieces of preset information corresponding to various indoor spaces may be stored in the memory 1800. A plurality of different indoor spaces may respectively correspond to a plurality of pieces of spatial information, and the plurality of pieces of spatial information may respectively correspond to the plurality of pieces of preset information. In other words, spatial information about the various indoor spaces may be pre-stored as preset information in the memory 1800 of the speaker device 1000. An embodiment of the disclosure in which one of the plurality of pieces of preset information is selected is already described with reference to FIG. 17, and thus, redundant descriptions thereof are not provided here.

Also, a method by which, when a user inputs indoor space information, the speaker device 1000 automatically selects the most relevant preset information may be used. FIG. 16 will now be referred to for this.

FIG. 16 illustrates an example of inputting an indoor space size to a speaker device, according to an embodiment of the disclosure.

Referring to FIG. 16, a user may directly input an indoor space size (width 4.3 m, length 6 m, and height 2.5 m) via the touch keypad 1725 that is a type of an input interface displayed on a screen of an indoor space size input mode on the display 1711 of the speaker device 1000. The processor of the speaker device 1000 may automatically select, from among the plurality of pieces of preset information, preset information having the smallest deviation from the input indoor space size. When the processor of the speaker device 1000 selects the preset information that has the smallest deviation from the input indoor space size and is from among the plurality of pieces of preset information, the processor may select the preset information having the smallest deviation from the input indoor space size by inputting the same weight to the width, the length, and the height, or may apply a weight to a particular value. For example, when a ‘height’ of an indoor space is not an important factor in selection of preset information, the processor may compare the preset information with the input indoor space size by applying a weight to a width and a length. For example, when calculating a deviation between the input indoor space size and preset information, the deviation may be calculated by applying 3 to the width, applying 3 to the length, and applying 1 to the height.

While FIG. 16 illustrates the example in which the user directly inputs information related to the indoor space size to the display 1711 on the speaker device 1000, the speaker device 1000 may receive the information related to the indoor space size from an external electronic device. For example, the user may input the information related to the indoor space size via the mobile device, and when communication between the mobile device and the speaker device 1000 is established, the speaker device 1000 may receive the information related to the indoor space size from the mobile device that is the external electronic device.

Description will be continued with reference to FIG. 13.

While an example in which a user inputs spatial information about an indoor space is already described with reference to FIG. 16, the processor 1100 may select one of a plurality of pieces of preset information, based on spatial information detected by the spatial detection sensor 1200.

According to an embodiment of the disclosure, spatial information may include position information of a user. In operation 1501 above, the speaker device 1000 may identify a position of a user via the user identification sensor 1300. That position information of a user is identified via the user identification sensor 1300 is already described above, and thus, redundant descriptions thereof are not provided here.

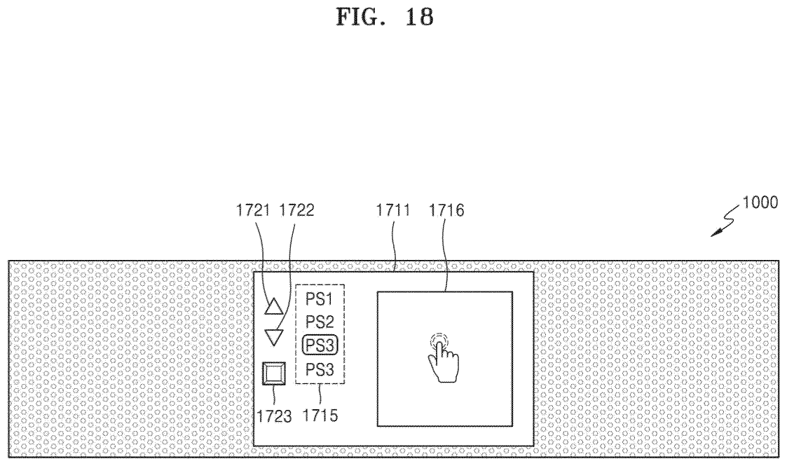

According to an embodiment of the disclosure, a user may provide the speaker device 1000 with preset information as to a position of the user. FIG. 18 will now be referred to for an example in which the user provides the speaker device 1000 with the position of the user.

FIG. 18 is a diagram for illustrating an example in which a user inputs a position of the user, according to an embodiment of the disclosure.

Referring to FIG. 18, the speaker device 1000 may display a preset list 1715 on the display 1711 that is a type of an output interface. The user may perform movement between the plurality of pieces of preset information by using the upward movement button 1721 and the downward movement button 1722. The display 1711 may display an indoor space plan view 1716 corresponding to preset information whenever the movement between the plurality of pieces of preset information occurs. While the indoor space plan view 1716 corresponding to the preset information being most relevant to an indoor space in which the speaker device 1000 is to be used is displayed, the user may display a position of the user. For example, the user may input the position of the user to the indoor space plan view 1716 via a touch.

The speaker device 1000 may receive a user input corresponding to the position of the user, and may include the user input in spatial information.

According to an embodiment of the disclosure, when the user designates the position of the user in the indoor space on the display, the user may designate the position of the user via a touch input, a voice input, a coordinate input, etc. When the speaker device 1000 provides the user with the indoor space plan view 1716, it may be provided via the display 1711 included in an output interface 1710, or, according to an embodiment of the disclosure, the speaker device 1000 may provide a separate external electronic device with an indoor space plan view in the form of data. The separate external electronic device may receive the data corresponding to the indoor space plan view from the speaker device 1000, and then may display the data on a display included in the external electronic device. In response to the data corresponding to the indoor space plan view, the user may provide the external electronic device with the position of the user via a touch input, a voice input, a coordinate input, etc. Modified data corresponding to the indoor space plan view including the position of the user may be transmitted from the external electronic device to the speaker device 1000. The speaker device 1000 may obtain spatial information including the modified data including the position of the user.

Description will be continued with reference to FIG. 15.

In operation 1503, according to an embodiment of the disclosure, the preset information may also include path information of an audio signal for generating a spatial sound effect. Therefore, according to an embodiment of the disclosure, when the spatial information is obtained by the spatial detection sensor 1200, the processor 1100 may select preset information corresponding to the obtained spatial information. In this regard, without a need to separately calculate a path of the audio signal for generating the spatial sound effect, the path of the audio signal for generating the spatial sound effect may be identified from the pre-stored preset information, and the processor 1100 may perform directivity control of the ultrasonic speaker 1500. Obviously, this is merely an embodiment of the disclosure, and when the path of the audio signal is not included in the preset information, in operation 1511, the processor 1100 may obtain (identify) the path of the audio signal, according to the selected preset information.

According to an embodiment of the disclosure, when the processor 1100 corresponds the obtained spatial information of the indoor space to at least one of the plurality of pieces of preset information, even when there is no preset information that exactly corresponds to the spatial information, the processor 1100 may automatically select preset information having the smallest deviation between a value included in the spatial information and a value included in the preset information, as the preset information corresponding to the obtained spatial information. The user may directly select preset information, however, when the spatial information of the indoor space is obtained by the spatial detection sensor 1200, the processor 1100 may select preset information being most relevant to the obtained spatial information of the indoor space. For example, it is assumed that a width of the indoor space is 4 m, a length thereof is 6 m, and a height thereof is 2.5 m, according to the spatial information obtained by the spatial detection sensor 1200. When it is assumed that preset 1 has values in which a width is 3 m, a length is 5.5 m, and a height is 2.3 m, and preset 2 has values in which a width is 4.5 m, a length is 6.5 m, and a height is 2.5 m, the processor 1100 may select preset 2 having the smallest deviation between the values included in the spatial information and the values included in the preset information. Obviously, this is merely an embodiment of the disclosure, and for example, when it is determined that a height of the indoor space is a value that is not important, values of a width and a length of the spatial information are compared with a width and a length of each of the plurality of pieces of preset information, and a preset having the smallest deviation between values may be selected. Therefore, according to an embodiment of the disclosure, when the spatial information is compared with preset information, a weight may be applied to a value (e.g., a width and length of the indoor space) that most highly affects a path of an audio signal for generating a spatial sound effect. Alternatively, according to an embodiment of the disclosure, when the processor 1100 compares the spatial information with preset information so as to select preset information, only a value that most highly affects a path of an audio signal for generating a spatial sound effect may be selectively compared.

The processor 1100 may select appropriate preset information among the plurality of pieces of preset information, or, according to an embodiment of the disclosure, the user may select preset information corresponding(mapping) to the spatial information among the plurality of pieces of preset information. This is already described with reference to FIG. 17, and thus, redundant descriptions thereof are not provided here.

In operation 1505, according to an embodiment of the disclosure, the processor 1100 may analyze an audio signal to be output, and thus, may identify channels corresponding to the audio signal. In operation 1507, the processor 1100 may identify speaker channels (speaker layout) of the speaker device 1000, and may compare the identified channels corresponding to the audio signal with the speaker channels (speaker layout) of the speaker device 1000.

For example, when channels of the audio signal are 7.1, based on a result of analyzing, by the processor 1100, the audio signal to be output, a full bandwidth channel of 20 Hz to 20 kHz and 1 low frequency channel (0.1 channel of 20 Hz to 80 Hz) are used for the audio signal. In order for the speaker device 1000 to cover frequency ranges of the audio signal corresponding to 5.1, the speaker device 1000 has to include a front center speaker C, a front left speaker L, a front right speaker R, a surround left speaker LS, a surround right speaker RS, a left rear speaker LB, a right rear speaker RB, and a subwoofer.

In operation 1507, according to an embodiment of the disclosure, the processor 1100 may identify the speaker channels (speaker layout) of the speaker device 1000, and may determine whether the speaker device 1000 is capable of covering all 7.1 channels corresponding to the audio signal. Speaker channels refer to information about a configuration of speakers for each frequency range included in the speaker device 1000. As in the example above, when the speaker device 1000 includes the front center speaker C, the front left speaker L, the front right speaker R, the surround left speaker LS, the surround right speaker RS, the left rear speaker LB, the right rear speaker RB, and the subwoofer, the speaker channels of the speaker device 1000 may be 7.1. When the speaker device 1000 includes only the front center speaker C, the front left speaker L, the front right speaker R, and the subwoofer, the speaker channels of the speaker device 1000 may be 3.1. Data or information about the speaker channels may be pre-stored in the memory 1800 of the speaker device 1000.

According to an embodiment of the disclosure, the processor 1100 may compare channels corresponding to an audio signal with the speaker channels of the speaker device 1000, and may determine to which channel the ultrasonic speaker 1500 is to be allocated.

As a result of the analysis performed by the processor 1100, when the channels of the audio signal to be output are 7.1 and the speaker channels of the speaker device 1000 are 3.1—in other words, when the speaker device 1000 includes only the front center speaker C, the front left speaker L, the front right speaker R, and the subwoofer, according to an embodiment of the disclosure, the processor 1100 may determine that the ultrasonic speaker 1500 is to be substituted for the surround left speaker LS and the surround right speaker RS and/or the left rear speaker LB and the right rear speaker RB. In other words, the processor 1100 may allocate the ultrasonic speaker 1500 to the surround left speaker LS and the surround right speaker RS, and the left rear speaker LB and the right rear speaker RB.

According to an embodiment of the disclosure, when the processor 1100 compares channels corresponding to an audio signal to be output with the speaker channels of the speaker device 1000, and determines for which channel the ultrasonic speaker 1500 is to be substituted—to which channel the ultrasonic speaker 1500 is to be allocate, the processor 1100 may allow the ultrasonic speaker 1500 to be primarily substituted for a speaker (spatial sound effect speaker) that corresponds to a channel for a spatial sound effect. The speaker that corresponds to the channel for the spatial sound effect may include at least one of a rear speaker, a side (surround) speaker, or a top speaker.

According to an embodiment of the disclosure, when the processor 1100 allocates the ultrasonic speaker 1500 to a speaker corresponding to the channel for the spatial sound effect among channels not included in the speaker device 1000, the processor 1100 may allocate the ultrasonic speaker 1500 to the speaker in order of the rear speaker, the side speaker, and the top speaker.

In operation 1509, according to an embodiment of the disclosure, the processor 1100 may include a non-directional low frequency signal in a first audio signal to be output from the front speaker 1400, the non-directional low frequency signal being equal to or less than a preset frequency and being of a spatial effect audio signal included in the audio signal to be output from the speaker device 1000. As operation 1509 is already described with reference to FIGS. 12 to 14, redundant descriptions thereof are not provided here.

In operation 1511, according to an embodiment of the disclosure, the processor 1100 may identify a path of a second audio signal output from the ultrasonic speaker 1500, according to the preset information selected based on the spatial information, and to which spatial effect speaker the ultrasonic speaker 1500 is allocated, according to comparison between channels corresponding to an audio signal and the speaker channels of the speaker device 1000. When the preset information already stores a path of the audio signal, the processor 1100 may use the already stored path of the audio signal as information for directivity of the ultrasonic speaker 1500.

The second audio signal output from the ultrasonic speaker 1500 may reach the user via reflection from a wall surface forming the indoor space. For example, according to the identified path, the second audio signal may be delivered to the user from the rear, the side, or the ceiling (the top of the indoor space) of the user. In this manner, the ultrasonic speaker 1500 allows the second audio signal to be reflected from the wall surface of the indoor space and then to reach the user, and thus, may generate the same effect as that an audio signal is generated by at least one of the rear speaker, the side speaker, or the top speaker, even when the speaker device 1000 does not include the rear speaker, the side speaker, or the top speaker.

According to an embodiment of the disclosure, the processor 1100 may identify a path of an audio signal related to the spatial sound effect in the indoor space, based on the selected preset information. Also, according to an embodiment of the disclosure, the processor 1100 may identify the path of the second audio signal to be output from the ultrasonic speaker 1500, based on to which spatial sound speaker the ultrasonic speaker 1500 is allocated, by comparing the channel corresponding to the audio signal and speaker channels of the speaker device 1000. When it is determined that the ultrasonic speaker 1500 is to be substituted for a rear speaker, a directivity direction of the ultrasonic speaker 1500 is changed to allow the second audio signal to be delivered from the both rear sides of the user. In this regard, a side directivity direction of the ultrasonic speaker 1500 may vary according to a width of the indoor space based on the spatial information. For example, when it is assumed that a distance between the speaker device 1000 and the user is constant, the greater the width of the indoor space is, the greater a side directivity angle of the ultrasonic speaker 1500 is. Also, when a length of the indoor space is long and the width is small, the side directivity angle of the ultrasonic speaker 1500 may decrease.

For example, when it is determined that the ultrasonic speaker 1500 is to be substituted for a top speaker, a directivity direction of the ultrasonic speaker 1500 is determined to allow the second audio signal to be delivered from the top of the user. In this regard, a top directivity direction of the ultrasonic speaker 1500 may vary according to a height of the indoor space based on the spatial information. For example, when it is assumed that a distance between the speaker device 1000 and the user is constant, the greater the height is, the greater a top directivity angle of the ultrasonic speaker 1500 is.

As another example, when it is determined that the ultrasonic speaker 1500 is to be substituted for a side speaker, a directivity direction of the ultrasonic speaker 1500 is determined to allow the second audio signal to be delivered from the side of the user. When it is determined that the ultrasonic speaker 1500 is to be substituted for the side speaker, not the rear speaker, the side directivity angle of the ultrasonic speaker 1500 becomes greater than a case in which the ultrasonic speaker 1500 is substituted for the rear speaker.

In operation 1513, according to an embodiment of the disclosure, the processor 1100 may control a directivity direction of the ultrasonic speaker 1500 to be changed by controlling the tilt motor 1510 and the pan motor 1520 of the speaker device 1000, according to the determined directivity direction of the ultrasonic speaker 1500. The tilt motor 1510 is a motor that operates to change an up and down angle Θₜᵢₗₜ of the ultrasonic speaker 1500, and the pan motor 1520 is a motor that operates to change a left and right angle Θₚₐₙ of the ultrasonic speaker 1500.

According to an embodiment of the disclosure, the processor 1100 may set EQ φ_{EQ} with respect to the ultrasonic speaker 1500, based on the spatial information. EQ setting for audio is described in detail above, and thus, redundant descriptions thereof are not provided here.

In operation 1515, according to an embodiment of the disclosure, the processor 1100 may control the second audio signal to be output via the ultrasonic speaker 1500 facing the directivity direction by the tilt motor 1510 and the pan motor 1520. Also, the processor 1100 outputs, via the front speaker 1400, the first audio signal that is of the spatial effect audio signal included in the audio signal, is equal to or less than a preset frequency, and includes a non-directional low frequency signal. The user (listener) may experience a spatial sound effect via the second audio signal that is output from the ultrasonic speaker 1500 and then is reflected from a wall surface so as to generate the spatial sound effect, without a separate spatial sound effect generation speaker such as the rear speaker, the side speaker, or the top speaker.

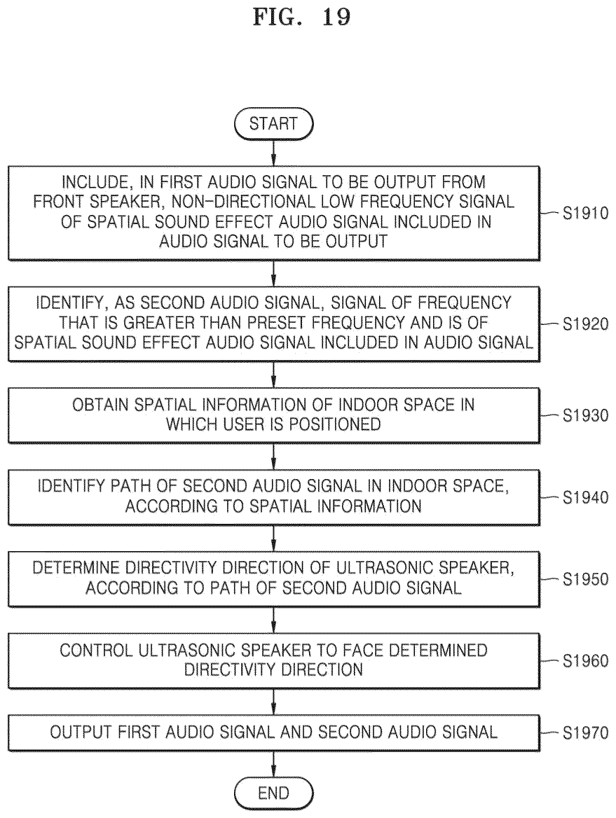

FIG. 19 is a flowchart illustrating a method of generating a spatial sound effect by a speaker device including an ultrasonic speaker, according to an embodiment of the disclosure.

In operation S1910, a non-directional low frequency signal that is of a spatial sound effect audio signal included in an audio signal to be output and is equal to or less than a preset frequency may be mixed into a first audio signal to be output from a front speaker. Here, the preset frequency may be 400 Hz or may be greater or less than 400 Hz.

In operation S1920, according to an embodiment of the disclosure, a frequency that is greater than the preset frequency and is of the spatial sound effect audio signal included in the audio signal to be output may be identified as a second audio signal to be output from the ultrasonic speaker 1500.

In operation S1930, according to an embodiment of the disclosure, spatial information of an indoor space in which a user is positioned may be obtained. The spatial information of the indoor space in which the user is positioned may be obtained by the spatial detection sensor 1200 or by a user input. Alternatively, the speaker device 1000 may receive and obtain the spatial information obtained by the spatial detection sensor 1200 included in an external electronic device, via communication from the external electronic device. According to an embodiment of the disclosure, the spatial information may include at least one information among an area of the indoor space, a length thereof, and a height thereof. According to an embodiment of the disclosure, the spatial information may include shape information of the indoor space, as to whether a shape of the indoor space is a rectangular shape, a round shape, an irregular polygonal shape, etc.

According to an embodiment of the disclosure, preset information that is most relevant to the indoor space in which the user is currently positioned and is from among a plurality of pieces of preset information stored in the memory of the speaker device 1000 and corresponding to a plurality of pieces of spatial information may be selected. For example, the plurality of pieces of spatial information may be respectively mapped to the plurality of pieces of preset information. In other words, spatial information about the various indoor spaces may be pre-stored as preset information in the memory of the speaker device 1000. One preset information among the plurality of pieces of preset information may be selected by selection by the user or the processor 1100 of the speaker device 1000.

According to an embodiment of the disclosure, the spatial information may also include position information of the user. According to an embodiment of the disclosure, the speaker device 1000 may identify a position of the user via the user identification sensor 1300. Alternatively, according to an embodiment of the disclosure, the user may provide the speaker device 1000 with preset information as to a position of the user.

In operation S1940, according to an embodiment of the disclosure, the preset information may also include path information of the second audio signal related to a spatial sound effect. Therefore, according to an embodiment of the disclosure, when the spatial information is determined, the processor 1100 does not need to separately calculate a path of the second audio signal, and may identify, from the pre-stored preset information, the path of the second audio signal.

According to an embodiment of the disclosure, when the preset information does not include the path information of the second audio signal, the path of the second audio signal related to the spatial sound effect may be identified based on the obtained spatial information.

In operation S1950, a directivity direction of the ultrasonic speaker 1500 may be determined according to the path of the second audio signal. The second audio signal output from the ultrasonic speaker 1500 may reach the user via reflection from a wall surface forming the indoor space. For example, according to the identified path, the second audio signal may be delivered to the user from the rear, the side, or the ceiling (the top of the indoor space) of the user. In this manner, the directivity direction of the ultrasonic speaker 1500 may be determined to allow the second audio signal to be reflected from the wall surface of the indoor space and then to reach the user, and thus, the ultrasonic speaker 1500 may generate the same effect as that an audio signal is generated by at least one of the rear speaker, the side speaker, or the top speaker, even when the speaker device 1000 does not include the rear speaker, the side speaker, or the top speaker.

According to an embodiment of the disclosure, a path of an audio signal related to a spatial sound effect in an indoor space may be identified, based on preset information selected based on spatial information, and a directivity direction of the ultrasonic speaker 1500 may be determined based on the identified path. According to an embodiment of the disclosure, the speaker device 1000 may compare channels corresponding to the audio signal with the speaker channels of the speaker device 1000, and may determine to which spatial sound speaker the ultrasonic speaker 1500 is to be allocated. Based on to which spatial sound speaker the ultrasonic speaker 1500 is allocated, a path of the second audio signal to be output from the ultrasonic speaker 1500 may be identified, and a directivity direction of the ultrasonic speaker 1500 may be determined based on the identified path.

When it is determined that the ultrasonic speaker 1500 is to be substituted for a rear speaker, a directivity direction of the ultrasonic speaker 1500 is changed to allow the second audio signal to be delivered from the both rear sides of the user. In this regard, a side directivity direction of the ultrasonic speaker 1500 may vary according to a width of the indoor space based on the spatial information. For example, when it is assumed that a distance between the speaker device 1000 and the user is constant, the greater the width of the indoor space is, the greater a side directivity angle of the ultrasonic speaker 1500 is. Also, when a length of the indoor space is long and the width is small, the side directivity angle of the ultrasonic speaker 1500 may decrease.

For example, when it is determined that the ultrasonic speaker 1500 is to be substituted for a top speaker, a directivity direction of the ultrasonic speaker 1500 is determined to allow the second audio signal to be delivered from the top of the user. In this regard, a top directivity direction of the ultrasonic speaker 1500 may vary according to a height of the indoor space based on the spatial information. For example, when it is assumed that a distance between the speaker device 1000 and the user is constant, the greater the height is, the greater a top directivity angle of the ultrasonic speaker 1500 is.

As another example, when it is determined that the ultrasonic speaker 1500 is to be substituted for a side speaker, a directivity direction of the ultrasonic speaker 1500 is determined to allow the second audio signal to be delivered from the side of the user. When it is determined that the ultrasonic speaker 1500 is to be substituted for the side speaker, not the rear speaker, the side directivity angle of the ultrasonic speaker 1500 becomes greater than a case in which the ultrasonic speaker 1500 is substituted for the rear speaker.

In operation S1960, according to an embodiment of the disclosure, the tilt motor 1510 and the pan motor 1520 of the speaker device 1000 are controlled according to the determined directivity direction of the ultrasonic speaker 1500, and a directivity direction of the ultrasonic speaker 1500 is controlled to be changed.

According to an embodiment of the disclosure, EQ with respect to the ultrasonic speaker 1500 may be set based on the spatial information. EQ setting for audio is described in detail above, and thus, redundant descriptions thereof are not provided here.

In operation S1970, according to an embodiment of the disclosure, the second audio signal is output via the ultrasonic speaker 1500 whose directivity direction is determined by the tilt motor 1510 and the pan motor 1520. Also, the first audio signal is output via the front speaker 1400. The user (listener) may experience a spatial sound effect via the second audio signal that is output from the ultrasonic speaker 1500 and then is reflected from a wall surface, without a separate spatial sound effect generation speaker such as the rear speaker, the side speaker, or the top speaker.

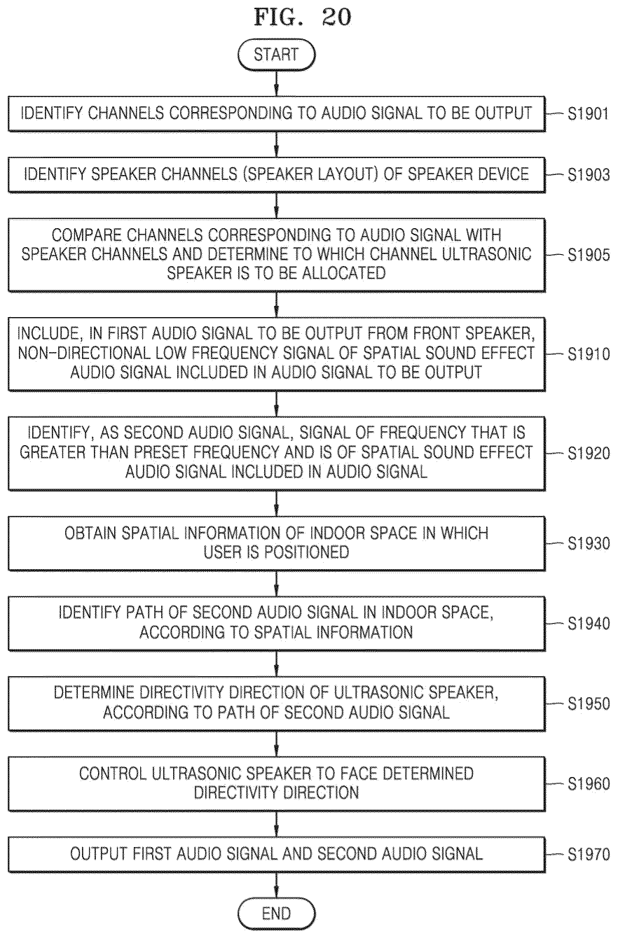

FIG. 20 is a flowchart illustrating a method of generating a spatial sound effect by a speaker device including an ultrasonic speaker, according to an embodiment of the disclosure.

In operation S1901, when an audio signal to be output via the speaker device 1000 is input to the speaker device 1000, channels corresponding to the audio signal are identified according to an analysis with respect to the audio signal to be output.

In operation S1903, speaker channels (speaker layout) of the speaker device 1000 are identified.

In operation S1905, the identified channels corresponding to the audio signal are compared with the speaker channels (speaker layout) of the speaker device 1000.

For example, when channels of the audio signal are 7.1, based on a result of the analysis with respect to the audio signal to be output, a full bandwidth channel of 20 Hz to 20 kHz and 1 low frequency channel (0.1 channel of 20 Hz to 80 Hz) are used for the audio signal. In order for the speaker device 1000 to cover frequency ranges of the audio signal corresponding to 7.1, the speaker device 1000 has to include a front center speaker C, a front left speaker L, a front right speaker R, a surround left speaker LS, a surround right speaker RS, a left rear speaker LB, a right rear speaker RB, and a subwoofer.

According to an embodiment of the disclosure, the speaker channels (speaker layout) of the speaker device 1000 are identified, and the speaker device 1000 may determine whether it is possible to cover all 7.1 channels corresponding to the audio signal. Speaker channels refer to information about a configuration of speakers for each frequency range included in the speaker device 1000. As in the example above, when the speaker device 1000 includes the front center speaker C, the front left speaker L, the front right speaker R, the surround left speaker LS, the surround right speaker RS, the left rear speaker LB, the right rear speaker RB, and the subwoofer, the speaker channels of the speaker device 1000 may be 7.1. When the speaker device 1000 includes only the front center speaker C, the front left speaker L, the front right speaker R, and the subwoofer, the speaker channels of the speaker device 1000 may be 3.1. Information about the speaker channels may be pre-stored in the memory 1800 of the speaker device 1000.

According to an embodiment of the disclosure, channels corresponding to an audio signal may be compared with the speaker channels of the speaker device 1000, and to which channel the ultrasonic speaker 1500 is to be allocated may be determined.

When the channels of the audio signal to be output are 7.1 and the speaker channels of the speaker device 1000 are 3.1—in other words, when the speaker device 1000 includes only the front center speaker C, the front left speaker L, the front right speaker R, and the subwoofer, according to an embodiment of the disclosure, the processor 1100 may determine that the ultrasonic speaker 1500 is to be substituted for the surround left speaker LS and the surround right speaker RS and/or the left rear speaker LB and the right rear speaker RB. In other words, the processor 1100 may allocate the ultrasonic speaker 1500 to the surround left speaker LS and the surround right speaker RS, and/or the left rear speaker LB and the right rear speaker RB.

According to an embodiment of the disclosure, when channels corresponding to an audio signal to be output are compared with the speaker channels of the speaker device 1000, and for which channel the ultrasonic speaker 1500 is to be substituted—to which channel the ultrasonic speaker 1500 is to be allocated—is determined, the ultrasonic speaker 1500 may be allocated to be primarily substituted for a speaker (spatial sound effect speaker) that corresponds to a channel for a spatial sound effect. The speaker that corresponds to the channel for the spatial sound effect may include at least one of a rear speaker, a side speaker, or a top speaker.

According to an embodiment of the disclosure, when the ultrasonic speaker 1500 is allocated to a speaker corresponding to the channel for the spatial sound effect among channels not included in the speaker device 1000, the ultrasonic speaker 1500 may be allocated to the speaker in order of the rear speaker, the side speaker, and the top speaker.

Operations S1910 to S1970 of FIG. 20 are equal to corresponding operations of FIG. 19, and thus, redundant descriptions thereof are not provided here.

However, when the path of the second audio signal is identified in operation S1940 of FIG. 20, according to operations S1901 to S1905 above, the path of the second audio signal may be identified based on the ultrasonic speaker 1500 being allocated to the speaker corresponding to the channel for the spatial sound effect. In other words, when the path of the second audio signal is identified, the path of the second audio signal may be differently identified or determined, according to whether the ultrasonic speaker 1500 is substituted for the rear speaker, is substituted for the side speaker, or is substituted for the top speaker.

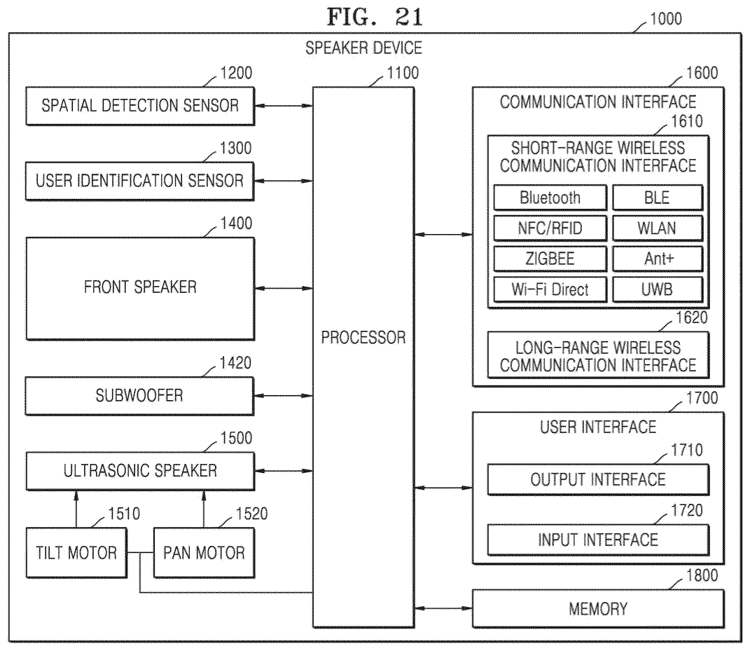

FIG. 21 is a block diagram of a speaker device including an ultrasonic speaker, according to an embodiment of the disclosure.

The speaker device 1000 may include the spatial detection sensor 1200, the user identification sensor 1300, the front speaker 1400, a subwoofer 1420, the ultrasonic speaker 1500, the tilt motor 1510, the pan motor 1520, the processor 1100, a communication interface 1600, a user interface 1700, and the memory 1800. Depending on manufacturing costs and the classification of use, the communication interface 1600 may not be included in the speaker device 1000. Also, selectively, the speaker device 1000 may not include the spatial detection sensor 1200, the user identification sensor 1300, and/or the subwoofer 1420.

According to an embodiment of the disclosure, the speaker device 1000 may obtain, via the spatial detection sensor 1200, spatial information of an indoor space in which the speaker device 1000 is positioned. The spatial detection sensor 1200 may include a sensor for detecting a depth or shape of the indoor space. The spatial detection sensor 1200 may be one of a LIDAR, a ToF camera, a stereo camera, an ultrasonic sensor, an infrared sensor, a 3D scanner, and a depth camera, but the disclosure is not limited thereto. The spatial detection sensor 1200 may collect 3D information about the indoor space.

According to an embodiment of the disclosure, the spatial detection sensor 1200 may detect at least one piece of information about an area, a length, and a height of the indoor space in which the speaker device 1000 is positioned. According to an embodiment of the disclosure, as the spatial detection sensor 1200 detects at least one piece of information about the area, the length, and the height of the indoor space, information about the shape of the indoor space may also be detected. For example, according to information detected by the spatial detection sensor 1200, whether the shape of the indoor space 10 is a square shape, a round shape, an irregular polygonal shape, etc. may be identified.

The user identification sensor 1300 may identify a position of a user in the indoor space in which the speaker device 1000 is positioned. The user identification sensor 1300 may include a sensor capable of not only identifying whether the user is present but also identifying a distance and an angle of the user from the speaker device 1000. Therefore, similar to the spatial detection sensor 1200, the user identification sensor 1300 may include a depth measurement sensor. The spatial detection sensor 1200 may be, for example, any one of an IR sensor, an ultrasonic sensor, a microwave (radar) sensor, a camera-based sensor, and a real-time position tracking sensor, but the disclosure is not limited thereto.

The spatial detection sensor 1200 and the user identification sensor 1300 may be included in the speaker device 1000 or may be included in the external electronic device. When the spatial detection sensor 1200 and the user identification sensor 1300 are included in the external electronic device, the speaker device 1000 may receive, from the external electronic device via communication, position information of the user and spatial information which are obtained via the spatial detection sensor 1200 and the user identification sensor 1300.

The speaker device 1000 may include the front speaker 1400. The front speaker 1400 may be a speaker for outputting an audio signal that does not generate a spatial sound effect. The front speaker 1400 may include at least one of the front center speaker C, the front left speaker L, the front right speaker R, or the subwoofer 1420. For example, the front speaker 1400 may include only the front center speaker C. Also, the subwoofer 1420 may not be included in the front speaker 1400 but may be separately included in the front speaker 1400.

The ultrasonic speaker 1500 is a speaker that uses an ultrasonic frequency, and generates frequencies equal to or greater than 20 kHz that is higher than a general human hearing range (i.e., 20 Hz to 20 kHz). The ultrasonic speaker 1500 has directivity that may be propagated in a particular direction in the air, and thus, may transmit an audio signal to be concentrated on a target point. Therefore, the ultrasonic speaker 1500 may make least noise and may transmit the audio signal in a particular space.

According to an embodiment of the disclosure, when the ultrasonic speaker 1500 transmits the audio signal at an appropriate angle to a wall surface of the indoor space, based on the directivity of the ultrasonic speaker 1500, the audio signal may be delivered from the left and right rear, the left and right sides, and the top of the user. Therefore, without a rear speaker, a side speaker, and a ceiling speaker, the ultrasonic speaker 1500 may perform functions of the speakers.

According to an embodiment of the disclosure, the ultrasonic speaker 1500 may be a speaker to be substituted for at least one of the surround left speaker LS, the surround right speaker RS, the left rear speaker LB, the right rear speaker RB, a left upper speaker LT, or a right upper speaker RT.

In order for the ultrasonic speaker 1500 to transmit an audio signal at an appropriate angle to a wall surface of the indoor space, the ultrasonic speaker 1500 may be mounted into the mount enabled for left and right movements and up and down movements. The left and right movements of the ultrasonic speaker 1500 may be performed by the pan motor 1520. When a directivity direction of the ultrasonic speaker 1500 is determined, the left and right movements of the ultrasonic speaker 1500 is performed by the pan motor 1520 and the up and down movements of the ultrasonic speaker 1500 is performed by the tilt motor 1510.

The communication interface 1600 may include a short-range wireless communication interface 1610 and a long-range wireless communication interface 1620. The short-range wireless communication interface 1610 may include a Bluetooth communicator, a Bluetooth low energy (BLE) communicator, a near-field communication (NFC) communicator, a wireless local area network (WLAN) (or Wi-Fi) communicator, a Zigbee communicator, an infrared data association (IrDA) communicator, a Wi-Fi direct (WFD) communicator, a ultra-wideband (UWB) communicator, or an Ant+communicator, but is not limited thereto. When the speaker device 1000 is remotely controlled by a server apparatus in an Internet of Things (IoT) environment, the long-range wireless communication interface 1620 may be used to communicate with the server apparatus. The long-range wireless communication interface 1620 may include Internet, a computer network (e.g., a local area network (LAN) or a wide area network (WAN)), or a mobile communication interface. The mobile communication interface transmits and receives wireless signals to and from at least one of a base station, an external device, or a server in a mobile communication network. Here, the wireless signals may include various types of data based on transmission and reception of voice call signals, video call signals, or text/multimedia messages. The mobile communication interface may include, but is not limited to, a 3^{rd} generation (3G) module, a 4^{th} generation (4G) module, a long term evolution (LTE) module, a 5^{th} generation (5G) module, a 6^{th} generation (6G) module, a narrowband Internet of Things (NB-IoT) module, a long term evolution for machine (LTE-M) module, etc.

The communication interface 1600 may transmit data to the external electronic device or may receive data from the external electronic device. For example, the communication interface 1600 may establish communication with the external electronic device and/or another home appliance which include the spatial detection sensor 1200 and/or the user identification sensor 1300, and may transmit or receive various types of data.

To this end, the communication interface 1600 may support establishment of a direct (e.g.: wired) communication channel or a wireless communication channel to external electronic device, and performing of communication via the established communication channel. According to an embodiment of the disclosure, the communication interface 1600 may include a wireless communication interface (e.g.: a cellular communication interface, a short-range wireless communication interface, or a global navigation satellite system (GNSS) communication interface) or a wired communication interface (e.g.: a LAN communication interface, or a power line communication module). A corresponding communication interface among the communication interfaces may communication may communicate with the external electronic device via short-range communication such a first network (e.g.: Bluetooth, wireless fidelity (Wi-Fi) direction or infrared data association (IrDA)) or long-range communication such as a second network (e.g.: a legacy cellular network, a 5G network, a next-generation communication network, Internet, or a computer network (e.g.: LAN or WAN)). The various types of communication interfaces may be integrated as one element (e.g.: single chip), or may be implemented as a plurality of separate elements (e.g.: multiple chips).

In an embodiment of the disclosure, the communication interface 1600 may communicate with external electronic devices including a server, a mobile device, another home appliance, etc. via a neighboring access point (AP). The AP may connect the LAN to which the speaker device 1000 and/or the mobile device is connected to the WAN to which the service is connected. The speaker device 1000 and/or a mobile device of a user may be connected to a server via the WAN.

The user interface 1700 may provide a user interface for interaction between the user and the speaker device 1000. The user interface 1700 may include at least one output interface 1710 and at least one input interface 1720.

The output interface 1710 may deliver various types of data related to an operation of the speaker device 1000 to the user. For example, the output interface 1710 may deliver information related to the speaker device 1000, the information including spatial information, preset information, etc., to the user. Information about the operation of the speaker device 1000 may be output through a display, a screen, an indicator, a voice, etc. The information about the operation of the speaker device 1000 may be output via the display 1711 as shown with reference to FIG. 16. The output interface 1710 may include a liquid crystal display (LCD) panel, a light-emitting diode (LED) panel, a speaker, etc.

The input interface 1720 may convert information received from the user into an electrical signal. The at least one input interface 1720 may include a power button, an operation button, etc. The input interface 1720 may include a tact switch, a push switch, a slide switch, a toggle switch, a micro switch, a touch switch, a touch pad, a touch screen, a jog dial, and/or a microphone. The input interface 1720 may include the touch keypad 1725 as shown in FIG. 16, and may include the upward movement button 1721, the downward movement button 1722, and the selection button 1723 as shown in FIG. 17.

The input interface 1720 may include a voice recognition module. For example, the speaker device 1000 may receive a voice signal that is an analog signal via a microphone, and may convert the voice part into a computer-readable text by using an automatic speech recognition (ASR) model. The speaker device 1000 may interpret the converted text by using a natural language understanding (NLU) model, and thus, may obtain an intention of user's utterance. Here, the ASR model or the NLU model may be an artificial intelligence (AI) model. The AI model may be processed by an AI-dedicated processor designed in a hardware structure specialized for processing an AI model. The AI model may be generated via a training process. Here, being generated via a training process may mean that predefined operation rules or AI model set to perform desired characteristics (or purposes), is generated by training a basic AI model by using a learning algorithm that utilizes a large amount of training data. The AI model may include a plurality of neural network layers. Each of the neural network layers may include a plurality of weight values, and may perform a neural network arithmetic operation via an arithmetic operation between an arithmetic operation result of a previous layer and the plurality of weight values.

Linguistic understanding is a technology to recognize and apply/process human language/characters and includes natural language processing, machine translation, dialogue systems, question answering, speech recognition/synthesis, and the like.

The processor 1100 may control various elements (the spatial detection sensor 1200, the user identification sensor 1300, the front speaker 1400, the subwoofer 1420, the ultrasonic speaker 1500, the tilt motor 1510, the pan motor 1520, the communication interface 1600, the user interface 1700, and the memory 1800) of the speaker device 1000. The processor 1100 may control various elements of the speaker device 1000 so as to allow the ultrasonic speaker 1500 to be substituted for a spatial sound effect generation speaker.

The processor 1100 may include hardware such as a processor, a central processing unit (CPU), a micom, a memory, etc. For example, the processor 1100 may include an algorithm for controlling operations of the elements in the speaker device 1000, the memory 1800 for storing data in the form of a program and an execution program, and at least one processor for performing the aforementioned operations and operations to be described below, by using the data stored in the memory 1800. The memory 1800 and the processor 1100 may be implemented as separate chips. The processor 1100 may include one processor chip or two or more processor chips, or may include one processing core or two or more processing cores. The memory 1800 may include one memory chip or two or more memory chips or may include one memory block or two or more memory blocks. Also, the memory 1800 and the processor 1100 may be implemented as a single chip.

The processor 1100 may include various types of processing circuitry and/or a plurality of processors. For example, the term “processor” used herein including claims may include various types of processing circuitry including at least one processor. One or more processors in the at least one processor may be configured to individually in a distributed manner or collectively perform various functions to be described here. As used herein, “processor”, “at least one processor”, and “one or more processors” may be configured to perform various functions. However, the recited terms cover a situation in which one processor performs a part of functions and other processor(s) performs the other part of the functions, and a situation in which one processor may perform all functions. Also, the processor 1100 may include a combination of processors configured to perform a variety of the disclosed functions in a distributed manner. The processor 1100 may execute program instructions to achieve or perform various functions. The processor 1100 may execute programs stored in the memory 1800 to control the speaker device 1000.

According to an embodiment of the disclosure, the processor 1100 may include an AI processor. The AI processor may be manufactured in the form of an AI-dedicated hardware chip, or may be manufactured as a part of an existing general-purpose processor (e.g.: CPU or application processor) or a graphic-dedicated processor (e.g.: GPU) and embedded in the speaker device 1000. In this case, the memory 1800 may include an AI model.

The memory 1800 may include at least one type of storage medium from among flash memory, a hard disk, a multimedia card micro, a memory card (e.g., a secure digital (SD) or extreme digital (XD) memory card), random access memory (RAM), static random access memory (SRAM), read-only memory (ROM), electrically erasable programmable read-only memory (EEPROM), programmable read-only memory (PROM), magnetic memory, a magnetic disk, and an optical disc. Also, the speaker device 1000 may run a web storage or a cloud server which performs a storage function on Internet.

According to an embodiment of the disclosure, a speaker device may include a front speaker, and an ultrasonic speaker configured to deliver, for a spatial sound effect, a spatial effect audio signal via reflection in an indoor space. According to an embodiment of the disclosure, at least one processor of the speaker device may be configured to identify spatial information of an indoor space. According to an embodiment of the disclosure, the at least one processor of the speaker device may be configured to include, in a first audio signal to be output from the front speaker, a low frequency signal extracted from a spatial effect audio signal included in an audio signal to be output. In an embodiment of the disclosure, the low frequency signal is non-directional and a frequency of the low frequency signal is equal to or less than a preset frequency. According to an embodiment of the disclosure, the at least one processor of the speaker device may be configured to identify, as a second audio signal, a high frequency signal extracted from the spatial effect audio signal included in the audio signal. In an embodiment of the disclosure, a frequency of the high frequency signal is greater than the preset frequency. According to an embodiment of the disclosure, the at least one processor of the speaker device may be configured to identify a path of the second audio signal in the indoor space, according to the spatial information, and determine a directivity direction of the ultrasonic speaker, according to the identified path of the second audio signal. According to an embodiment of the disclosure, the at least one processor of the speaker device may be configured to control the ultrasonic speaker to face the determined directivity direction. According to an embodiment of the disclosure, the at least one processor of the speaker device may be configured to control the ultrasonic speaker to output the second audio signal.

According to an embodiment of the disclosure, the at least one processor of the speaker device may be configured to identify channels according to the audio signal, and compare the channels according to the audio signal with speaker channels of the speaker device, and, when the speaker channels of the speaker device which correspond to the channels according to the audio signal do not exist, allocate the ultrasonic speaker to at least one of channels requested according to the audio signal.

According to an embodiment of the disclosure, the at least one processor of the speaker device may be configured to identify the path of the second audio signal, based on the ultrasonic speaker being allocated to at least one of the channels requested according to the audio signal.

According to an embodiment of the disclosure, the at least one processor of the speaker device may be configured to, when the speaker channels of the speaker device which correspond to the channels according to the audio signal do not exist, allocate the ultrasonic speaker to a speaker that corresponds to a speaker channel for a spatial sound effect and is among speaker channels not included in the speaker device.

According to an embodiment of the disclosure, in the speaker device, the speaker that corresponds to the speaker channel for the spatial sound effect may include at least one of a rear speaker, a side speaker, or a top speaker.

According to an embodiment of the disclosure, the at least one processor of the speaker device may be configured to allocate the ultrasonic speaker to the speaker in order of the rear speaker, the side speaker, and the top speaker, when the at least one processor allocates the ultrasonic speaker to the speaker that corresponds to the speaker channel for the spatial sound effect and is among the speaker channels not included in the speaker device.

According to an embodiment of the disclosure, the speaker device may further include a memory storing a plurality of pieces of preset information, wherein the plurality of pieces of preset information respectively correspond to a plurality of pieces of spatial information according to different indoor spaces.

According to an embodiment of the disclosure, the at least one processor of the speaker device may be configured to map the obtained spatial information of the indoor space to at least one preset information among the plurality of pieces of preset information, and identify the path of the second audio signal in the indoor space according to the mapped preset information among the plurality of pieces of preset information.

According to an embodiment of the disclosure, in the speaker device, each of the plurality of pieces of preset information may include information about at least one of a length, a width, or a height of a corresponding indoor space and path information of an audio signal for the spatial sound effect according to the corresponding indoor space.

According to an embodiment of the disclosure, in the speaker device, each of the plurality of pieces of preset information may further include information about a shape of the corresponding indoor space.

According to an embodiment of the disclosure, in the speaker device, the spatial information may include information about at least one of a length, a width, or a height of the indoor space.

According to an embodiment of the disclosure, the at least one processor of the speaker device may be configured to map the spatial information of the indoor space to preset information having a smallest deviation between the information about at least one of the length, the width, or the height of the indoor space included in the spatial information and a plurality of pieces of information about at least one of lengths, widths, or heights of indoor spaces corresponding to the plurality of pieces of preset information.

According to an embodiment of the disclosure, the at least one processor of the speaker device may be configured to control the directivity direction of the ultrasonic speaker by moving the ultrasonic speaker in left and right directions or up and down directions according to the identified path of the second audio signal.

According to an embodiment of the disclosure, the at least one processor of the speaker device may be configured to set equalization with respect to the ultrasonic speaker, based on the spatial information.

According to an embodiment of the disclosure, the speaker device may further include a user identification sensor configured to identify a position of a user, and the spatial information may further include a position of the user.

According to an embodiment of the disclosure, the user identification sensor of the speaker device may be further configured to identify a position of the user in real time. According to an embodiment of the disclosure, the at least one processor of the speaker device may be configured to change the path of the second audio signal having the directivity direction, according to the position of the user, the position changing in real time.

According to an embodiment of the disclosure, the ultrasonic speaker of the speaker device may be configured to output the second audio signal having a directivity in the indoor space, so that a user facing the speaker device listens to the second audio signal from the rear, the side, or the top in the indoor space.

According to an embodiment of the disclosure, the speaker device may further include a spatial detection sensor configured to obtain spatial information of the indoor space in which a user is positioned.

According to an embodiment of the disclosure, the at least one processor of the speaker device may be configured to identify the spatial information, based on the spatial information of the indoor space which is obtained by the spatial detection sensor.

According to an embodiment of the disclosure, the speaker device may further include a memory storing a plurality of pieces of preset information, wherein each of the plurality of pieces of preset information is respectively mapped to each of a plurality of pieces of spatial information according to different indoor spaces.

According to an embodiment of the disclosure, the at least one processor of the speaker device may be configured to identify, as the spatial information of the indoor space, at least one of the plurality of pieces of preset information, based on selection by a user.

According to an embodiment of the disclosure, a method of outputting audio from a speaker device is provided. According to an embodiment of the disclosure, the method may include including, in a first audio signal to be output from a front speaker, a non-directional low frequency signal that is of a spatial effect audio signal included in an audio signal to be output from the speaker device and is equal to or less than a preset frequency. According to an embodiment of the disclosure, the method may include identifying, as a second audio signal, a signal of a frequency that is greater than the preset frequency and is of the spatial effect audio signal included in the audio signal. According to an embodiment of the disclosure, the method may include obtaining spatial information of an indoor space in which a user is positioned. According to an embodiment of the disclosure, the method may include identifying a path of a second audio signal in the indoor space, according to the spatial information of the indoor space. According to an embodiment of the disclosure, the method may include determining a directivity direction of the ultrasonic speaker, according to the identified path of the second audio signal. According to an embodiment of the disclosure, the method may include controlling the ultrasonic speaker to face the determined directivity direction. According to an embodiment of the disclosure, the method may include outputting the first audio signal and the second audio signal.

According to an embodiment of the disclosure, in the method, the determining of the directivity direction of the ultrasonic speaker may include identifying a speaker layout, according to the audio signal. The determining of the directivity direction of the ultrasonic speaker may include determining the directivity direction of the ultrasonic speaker, according to the identified path of the second audio signal and the speaker layout.

According to an embodiment of the disclosure, the method may further include comparing the identified speaker layout with channels of the speaker device, and when no channel of the speaker device corresponds to requested channels of the speaker layout, allocating the ultrasonic speaker to at least one of the requested channels of the speaker layout.

A machine-readable storage medium may be provided in the form of a non-transitory storage medium. Here, the term ‘non-transitory storage medium’ may mean that the storage medium is a tangible device and does not include signals (e.g., electromagnetic waves), and may mean that data may be permanently or temporarily stored in the storage medium. For example, the ‘non-transitory storage medium’ may include a buffer in which data is temporarily stored.

According to an embodiment of the disclosure, the method according to an embodiment of the disclosure may be included and provided in a computer program product. The computer program product may be traded as a product between a seller and a buyer. The computer program product may be distributed in the form of a machine-readable storage medium (e.g., a compact disc read only memory (CD-ROM)) or may be distributed (e.g., downloaded or uploaded) online through an application store or directly between two user apparatuses (e.g., smartphones). In a case of online distribution, at least a portion of the computer program product (e.g., a downloadable application) may be at least temporarily stored or temporarily generated in a machine-readable storage medium such as a manufacturer's server, a server of an application store, or a memory of a relay server.

What is claimed is:

1. A speaker device comprising:
a front speaker;
an ultrasonic speaker configured to provide, for a spatial sound effect, a spatial effect audio signal via reflection in an indoor space;
memory storing instructions; and
at least one processor,
wherein the instructions, when executed by the at least one processor individually or collectively, cause the speaker device to:
identify spatial information of the indoor space,
include, in a first audio signal to be output from the front speaker, a low frequency signal extracted from the spatial effect audio signal included in a third audio signal to be output, wherein the low frequency signal is non-directional and a frequency of the low frequency signal is less than or equal to a preset frequency,
identify, as a second audio signal, a high frequency signal extracted from the spatial effect audio signal included in the second audio signal, wherein a frequency of the high frequency signal is greater than the preset frequency,
identify a path of the second audio signal in the indoor space, according to the spatial information,
identify a directivity direction of the ultrasonic speaker, according to the identified path of the second audio signal;
control the ultrasonic speaker to face the identified directivity direction, and
control the ultrasonic speaker to output the second audio signal.

2. The speaker device of claim 1, wherein the instructions, when executed by the at least one processor individually or collectively, cause the speaker device to:
identify channels according to the third audio signal, and
compare the channels according to the third audio signal with speaker channels of the speaker device, and based on the speaker channels of the speaker device which correspond to the channels according to the third audio signal not existing, allocate the ultrasonic speaker to at least one of channels requested according to the third audio signal.

3. The speaker device of claim 2, wherein the instructions, when executed by the at least one processor individually or collectively, cause the speaker device to identify the path of the second audio signal, based on the ultrasonic speaker being allocated to at least one of the channels requested according to the third audio signal.

4. The speaker device of claim 3, wherein the instructions, when executed by the at least one processor individually or collectively, cause the speaker device to, based on the speaker channels of the speaker device which correspond to the channels according to the third audio signal not existing, allocate the ultrasonic speaker to a speaker that corresponds to a speaker channel for a spatial sound effect and is among the speaker channels not included in the speaker device.

5. The speaker device of claim 4, wherein the speaker that corresponds to the speaker channel for the spatial sound effect comprises at least one of a rear speaker, a side speaker, or a top speaker.

6. The speaker device of claim 5, wherein the instructions, when executed by the at least one processor individually or collectively, cause the speaker device to:
allocate the ultrasonic speaker to the speaker in order of the rear speaker, the side speaker, and the top speaker, based on the ultrasonic speaker being allocated to the speaker that corresponds to the speaker channel for the spatial sound effect and the speaker channel being among the speaker channels not included in the speaker device.

7. The speaker device of claim 1, wherein the memory stores a plurality of pieces of preset information that respectively correspond to a plurality of pieces of spatial information according to different indoor spaces, and
wherein the instructions, when executed by the at least one processor individually or collectively, cause the speaker device to:
map the spatial information of the indoor space to at least one preset information among the plurality of pieces of preset information, and
identify the path of the second audio signal in the indoor space according to the mapped at least one preset information among the plurality of pieces of preset information.

8. The speaker device of claim 7, wherein each piece of preset information of the plurality of pieces of preset information comprises information about at least one of a length, a width, or a height of a corresponding indoor space and path information of a fourth audio signal for the spatial sound effect according to the corresponding indoor space.

9. The speaker device of claim 8, wherein each piece of preset information of the plurality of pieces of preset information further comprises information about a shape of the corresponding indoor space.

10. The speaker device of claim 8, wherein the spatial information comprises information about at least one of the length, the width, or the height of the indoor space, and
wherein the instructions, when executed by the at least one processor individually or collectively, cause the speaker device to map the spatial information of the indoor space to preset information having a smallest deviation between the information about at least one of the length, the width, or the height of the indoor space included in the spatial information and a plurality of pieces of information about at least one of lengths, widths, or heights of indoor spaces corresponding to the plurality of pieces of preset information.

11. The speaker device of claim 1, wherein the instructions, when executed by the at least one processor individually or collectively, cause the speaker device to control the directivity direction of the ultrasonic speaker by moving the ultrasonic speaker in a left direction, a right direction, an up direction, or a down direction, according to the identified path of the second audio signal.

12. The speaker device of claim 11, wherein the instructions, when executed by the at least one processor individually or collectively, cause the speaker device to set equalization with respect to the ultrasonic speaker, based on the spatial information.

13. The speaker device of claim 1, further comprising a user identification sensor configured to identify a position of a user,
wherein the spatial information further comprises the position of the user.

14. The speaker device of claim 13, wherein the user identification sensor is further configured to identify the position of the user in real time, and
wherein the instructions, when executed by the at least one processor individually or collectively, cause the speaker device to change the path of the second audio signal having the directivity direction according to the position of the user, wherein the position changes in real time.

15. The speaker device of claim 1, wherein the ultrasonic speaker is configured to output the second audio signal having a directivity in the indoor space, so that a user facing the speaker device is positioned to listen to the second audio signal from the rear, the side, or the top in the indoor space.

16. The speaker device of claim 1, further comprising a spatial detection sensor configured to obtain the spatial information of the indoor space in which a user is positioned,
wherein the instructions, when executed by the at least one processor individually or collectively, cause the speaker device to identify the spatial information, based on the spatial information of the indoor space obtained by the spatial detection sensor.

17. The speaker device of claim 1, wherein the memory stores a plurality of pieces of preset information, and each of the plurality of pieces of preset information is respectively mapped to each of a plurality of pieces of spatial information according to different indoor spaces, and
wherein the instructions, when executed by the at least one processor individually or collectively, cause the speaker device to identify, as the spatial information of the indoor space, at least one of the plurality of pieces of preset information, based on a selection by a user.

18. A method of outputting audio from a speaker device comprising an ultrasonic speaker, the method comprising:
including, in a first audio signal to be output from a front speaker, a low frequency signal that is extracted from a spatial effect audio signal included in a third audio signal to be output from the speaker device, wherein the low frequency signal is non-directional and has a frequency that is less than or equal to a preset frequency;
identifying, as a second audio signal, a high frequency signal extracted from the spatial effect audio signal included in the third audio signal, wherein a frequency of the high frequency signal is greater than the preset frequency;
identifying spatial information of an indoor space in which a user is positioned;
identifying a path of the third audio signal in the indoor space, according to the spatial information of the indoor space;
identifying a directivity direction of the ultrasonic speaker, according to the identified path of the second audio signal;
controlling the ultrasonic speaker to face the identified directivity direction; and
outputting the second audio signal via the ultrasonic speaker.

19. The method of claim 18, wherein the identifying the directivity direction of the ultrasonic speaker comprises:
identifying a speaker layout, according to the second audio signal; and
identifying the directivity direction of the ultrasonic speaker, according to the identified path of the second audio signal and the speaker layout.

20. The method of claim 19, further comprising comparing the identified speaker layout with channels of the speaker device, and based on no channel of the speaker device corresponding to requested channels of the speaker layout, allocating the ultrasonic speaker to at least one of the requested channels of the speaker layout.
